(19) United States
(12) Patent Application Publication
(10) Pub. No.: US 2026/0277653 A1
(43) Pub. Date: Sep. 17, 2026

(54) DEPLOYING AUTONOMOUS SOFTWARE AGENTS AS INDEPENDENT VIRTUAL MACHINE COMPUTING DEVICES TO PERFORM SOFTWARE PROGRAMMING TASKS

(71) Applicant: COGNITION AI, INC., San Francisco, CA (US)

(72) Inventors: Tony Jiang, Sunnyvale, CA (US); Scott Wu, Atherton, CA (US); Steven Hao, Atherton, CA (US); Sampriti Panda, Menlo Park, CA (US); Walden Yan, Atherton, CA (US); Adhyyan Sekhsaria, San Francisco, CA (US); Jeffrey Ling, Redwood City, CA (US); Moritz Stephan, San Francisco, CA (US); Silas Alberti, San Francisco, CA (US); Gennady Korotkevich, Menlo Park, CA (US)

(21) Appl. No.: 19/561,145

(22) Filed: Mar. 9, 2026

Related U.S. Application Data
(60) Provisional application No. 63/770,816, filed on Mar. 12, 2025.

(51) Int. Cl. G06F 9/455; G06F 8/60; G06Q 10/0631

(52) U.S. Cl. CPC G06F 9/45558; G06F 8/60; G06Q 10/06316; G06F 2009/4557

(57) ABSTRACT

The present disclosure relates to systems, methods, and non-transitory computer-readable media that executes a software task utilizing an autonomous software agent. In particular, the disclosed systems receive a request to deploy an autonomous software agent, and the disclosed systems provide access to a shell and an integrated development environment. Moreover, the disclosed systems, execute, by the autonomous software agent, the software task responsive to the request based on utilizing the shell and the integrated development environment.

### CROSS REFERENCE TO RELATED APPLICATIONS

This application claims the benefit of and priority to U.S. Provisional Application No. 63/770,816, filed Mar. 12, 2025. The aforementioned application is hereby incorporated by reference in its entirety.

### BACKGROUND

Advancements in computing devices and networking technology have given rise to a variety of innovations in machine learning and digital co-pilot assistants. Over time, computing systems have been developed that generate computer code to assist (e.g., in a co-pilot like manner) a software developer in completing their computer tasks. For instance, some existing systems can assist software developers in generating code by supplementing computer code or making tweaks to existing computer code. Despite these advances, however, existing systems continue to suffer from a number of disadvantages, particularly in terms of computational efficiency, technical accuracy, and operational flexibility.

### SUMMARY

One or more embodiments described herein provide benefits and/or solve one or more problems in the art with systems, methods, and non-transitory computer-readable media that deploy autonomous software agents which operate within an independent virtual machine computing environment and are based on a unique artificial intelligence architecture. To illustrate, in one or more embodiments, the disclosed systems receive a request to activate an autonomous software agent to perform a software task. In response to the request, the disclosed systems deploy an autonomous software agent to perform the software task (e.g., generate computer code, create an application end-to-end, fine-tune an artificial intelligence model, debug computer code, etc.).

In one or more embodiments, the disclosed systems deploy an autonomous software agent that has a unique suite of software composition tools. In some embodiments, the disclosed systems provide the autonomous software agent with a development box to run terminal commands (e.g., utilizing a shell tool), browse the web (e.g., utilizing a browser tool), draft computer code (e.g., utilizing an integrated development environment), and plan an execution of software tasks (e.g., utilizing a planner tool).

Additional features and advantages of one or more embodiments of the present disclosure are outlined in the description which follows, and in part will be obvious from the description, or may be learned by the practice of such example embodiments.

### BRIEF DESCRIPTION OF THE DRAWINGS

This disclosure will describe one or more embodiments of the invention with additional specificity and detail by referencing the accompanying figures. The following paragraphs briefly describe those figures, in which:

FIG. 1 illustrates an overview diagram of an autonomous software agent system deploying an autonomous software agent in accordance with one or more implementations;

FIG. 2 illustrates an example diagram of the autonomous software agent system accessing computer software composition tools to execute a software task in accordance with one or more implementations;

FIG. 3 illustrates an example diagram of the autonomous software agent system utilizing a planner tool to analyze a request and generate an artificial intelligence plan in accordance with one or more implementations;

FIG. 4 illustrates an example diagram of the autonomous software agent system utilizing a browser tool to perform one or more website browsing actions in accordance with one or more implementations;

FIG. 5 illustrates an example diagram of the autonomous software agent system utilizing a shell tool to generate one or more terminal commands in accordance with one or more implementations;

FIG. 6 illustrates an example diagram of the autonomous software agent system utilizing an integrated development environment to generate computer code in accordance with one or more implementations;

FIG. 7 illustrates an example diagram of an architectural layer design of the autonomous software agent system which accesses various artificial intelligence models to enable an independent virtual machine computing environment of an autonomous software agent in accordance with one or more implementations;

FIG. 8 illustrates an example diagram of a virtual private cloud housing an independent virtual machine computing environment that is in communication with an autonomous agent model backend in accordance with one or more implementations;

FIG. 9 illustrates an example diagram of a frontend layer interacting with an autonomous software agent system ingestion layer and a virtual private cloud in accordance with one or more implementations;

FIGS. 10A-10G illustrates example graphical user interfaces of configuration options for an autonomous software agent and interfaces of computer software composition tools of the autonomous software agent system in accordance with one or more implementations;

FIGS. 11A-11J illustrates an example workflow of deploying an autonomous software agent to perform a task of generating a website in accordance with one or more implementations;

FIG. 12 illustrates an example environment of the autonomous software agent system in accordance with one or more implementations;

FIG. 13 illustrates an example series of acts for deploying an autonomous software agent in accordance with one or more implementations;

FIG. 14 illustrates an example series of acts for providing for display in a graphical user interface, computer software composition tools of the independent virtual machine computing environment in accordance with one or more implementations; and

FIG. 15 illustrates a block diagram of an exemplary computing device in accordance with one or more implementations.

### DETAILED DESCRIPTION

One or more embodiments described herein includes an autonomous artificial intelligence software agent that operates within an independent virtual machine computing environment to execute a software task utilizing one or more computer software composition tools. To illustrate, in one or more embodiments, an autonomous software agent system 100 deploys an autonomous software agent to independently complete software development tasks such as writing computer code tests, adding features to an existing code repository, adding functionality to an existing codebase, developing prototypes, and building integrations between software applications. As mentioned, the autonomous software agent system 100 deploys an autonomous software agent that operates within an independent virtual machine computing environment and the autonomous software agent is enabled to locally write computer code, test computer code, submit requests, and merge code into a codebase. In other words, the autonomous software agent system 100 deploys one or more autonomous software agents to independently perform a variety of non-trivial tasks, which enhances overall efficiency, accuracy, and operational flexibility of code development environments.

In some embodiments, the autonomous software agent system 100 provides computer software composition tools (e.g., development box tools) to an autonomous software agent and further provides a graphical user interface for a user to monitor/modify the progress of the autonomous software agent. In particular, the autonomous software agent system provides a variety of interfaces such as a shell interface (e.g., a terminal interface to interact with a computer’s operating system), an editor interface (e.g., an integrated development environment), a planner interface, and a browser interface for a user to monitor/modify the progress of the autonomous software agent executing a software task.

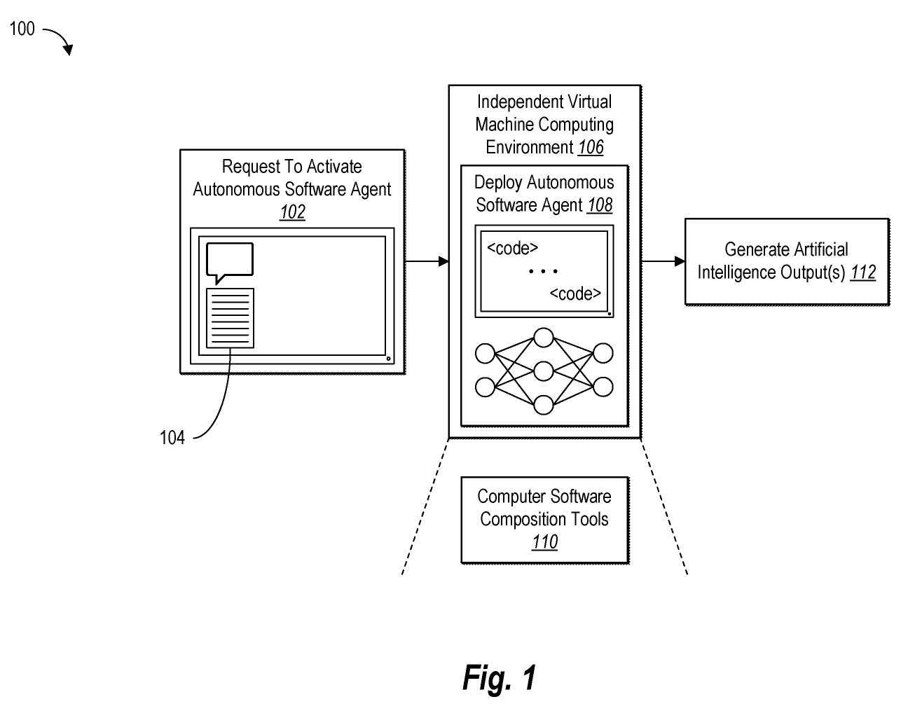

FIG. 1 illustrates an overview diagram of the autonomous software agent system 100 deploying an autonomous software agent to generate one or more artificial intelligence outputs that are responsive to a software task in accordance with one or more embodiments. For example, FIG. 1 shows the autonomous software agent system 100 accessing/receiving a request 102 to active an autonomous software agent.

In one or more embodiments, the request 102 refers to a natural language prompt (from a user computing device), an application programming interface call, and/or a tag/mention in a third-party messaging application received by the autonomous software agent system 100. In one or more embodiments, the request 102 refers to a prompt, a question, or an instruction submitted by a user of a user account corresponding to a computing device (e.g., a user computing device). In particular, the request 102 includes text instructions and/or image data received from a user computing device.

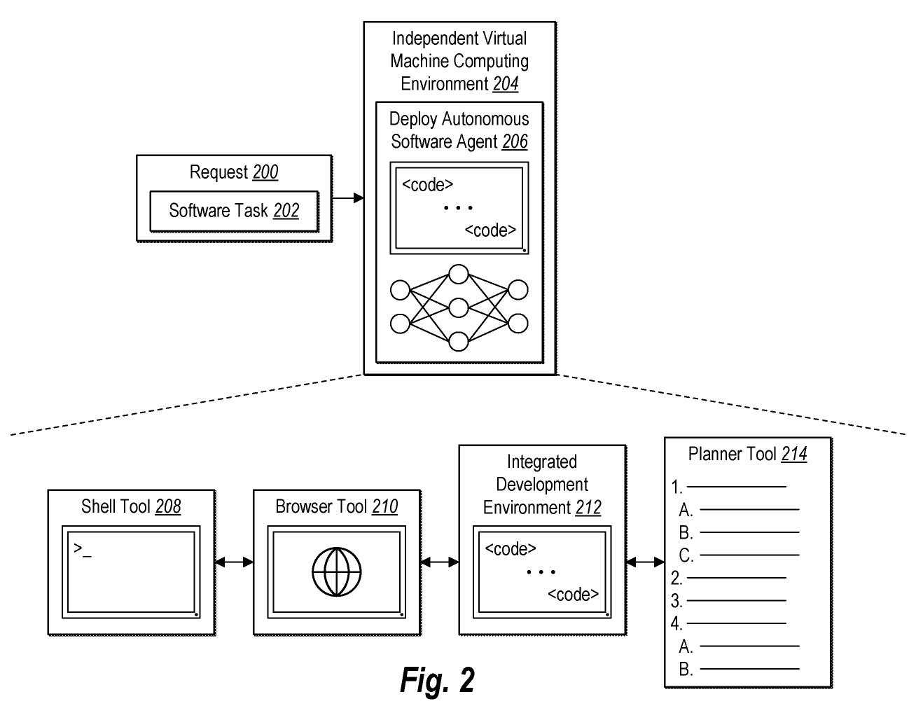

As shown in FIG. 1, in some embodiments, the autonomous software agent system 100 receives the request 102 via a chat interface 104 (between a user computing device and the autonomous software agent system 100). In particular, the autonomous software agent system 100 provides the chat interface 104 via a web browser, or a web application. Additional details regarding the autonomous software agent system 100 receiving the request 102 is given below in the description of FIG. 2.

As further shown in FIG. 1, the autonomous software agent system 100 further performs an act 108 of deploying an autonomous software agent (e.g., a cloned virtual machine that is isolated and can perform tasks siloed from other virtual machine computing devices). In particular, FIG. 1 shows the autonomous software agent system 100 deploying the autonomous software agent within an independent virtual machine computing environment 106 and generates and runs code in its own isolated environment. In other words, the autonomous software agent exists independently of a computing device of a user who submitted a prompt to deploy the autonomous software agent and performs tasks based on knowledge that is provided to it. Moreover, as shown in FIG. 1, the autonomous software agent system 100 further provides to the autonomous software agent, computer software composition tools 110. Details pertaining to the computer software composition tools 110 are given in more detail below in the description of FIGS. 2-6.

In one or more embodiments, the autonomous software agent system 100 provides the autonomous software agent with its own software development environment (e.g., the independent virtual machine computing environment 106 with access to the computer software composition tools 110) to perform individualized tasks and not merely supplementary tasks (e.g., the autonomous software agent can deploy its own codebase by replicating an existing codebase, make changes to an existing codebase, implement changes to a codebase, and run tests for computer code generated by an autonomous software agent).

In some embodiments, the autonomous software agent includes a set of artificial intelligence models. In particular, the autonomous software agent includes one or more machine learning models, neural networks, large language models, chain-of-thought reasoning models, and/or vision-language models. Thus, the autonomous software agent system 100 deploys an autonomous software agent that operates within an independent virtual machine computing device with various machine learning components used to analyze, process, and generate information. In one or more embodiments a machine learning model includes a computer algorithm or a collection of computer algorithms that can be trained and/or tuned based on inputs to approximate unknown functions. For example, a machine learning model can include a computer algorithm with branches, weights, or parameters that changed based on training data to improve for a particular task. Thus, a machine learning model can utilize one or more learning techniques to improve in accuracy and/or effectiveness. Example machine learning models include various types of decision trees, support vector machines, Bayesian networks, random forest models, or neural networks (e.g., deep neural networks).

Similarly, a neural network includes a machine learning model of interconnected artificial neurons (e.g., organized in layers) that communicate and learn to approximate complex functions and generate outputs based on a plurality of inputs provided to the model. In some instances, a neural network includes an algorithm (or set of algorithms) that implements deep learning techniques that utilize a set of algorithms to model high-level abstractions in data. To illustrate, in some embodiments, a neural network includes a convolutional neural network, a recurrent neural network (e.g., a long short-term memory neural network), a transformer neural network, a generative adversarial neural network, a graph neural network, a diffusion neural network, a multi-layer perceptron, a large language model (LLM), a generative pre-trained transformer model (GPT), a chain-of-thought machine learning model, etc. In some embodiments, a neural network includes a combination of neural networks or neural network components.

In one or more embodiments, a language model includes a set of statistical or probabilistic functions to perform Natural Language Processing (NLP) in order to understand, learn, and/or generate human natural language content. For example, the autonomous software agent system 100 uses a language model as a tool that determines the probability of a given sequence of words occurring in a sentence or natural language sequence. Simply put, the autonomous software agent system 100 uses a model that is trained to predict the next word in a sentence. A language model is called a large language model (LLM) when it is trained on an enormous amount of data (e.g., a threshold amount of data) and/or has a large number of parameters. These models have capabilities ranging from writing a simple essay to generating complex computer codes – all with limited to no supervision. Accordingly, an LLM can comprise a deep neural network that is very large (billions to hundreds of billions of parameters) and understands, processes, and produces human natural language by being trained on massive amounts of text.

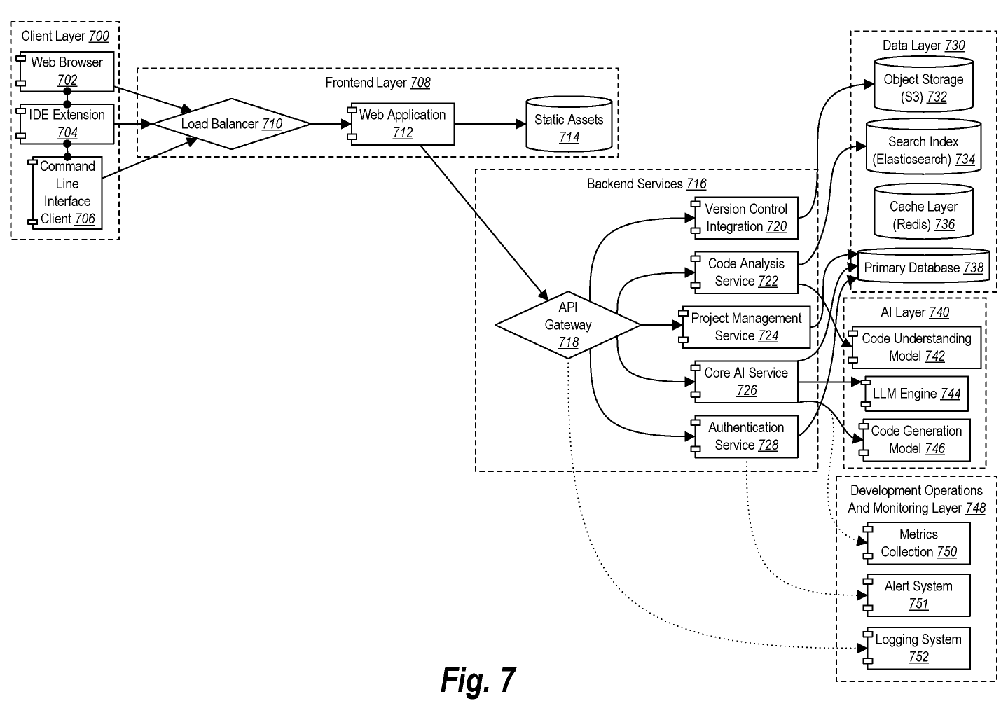

These models predict future words in a sentence letting them generate sentences similar to how humans talk and write or otherwise in a form dictated, for instance, by a prompt. In one or more implementations, an LLM utilized by the autonomous software agent system 100 employs a “chain-of-thought” reasoning approach that allows the model to internally deliberate before providing responses. Indeed, one or more implementations include a LLM trained using reinforcement learning techniques that enable the LLM to refine its reasoning skills through iterative feedback. Additional details of the autonomous software agent are given below in the description of FIGS. 7-9.

As shown in FIG. 1, the autonomous software agent system 100 deploys the autonomous software agent to access the computer software composition tools 110 and generate outputs responsive to the request 102. In particular, FIG. 1 shows the autonomous software agent system 100 performing an act 112 of generating one or more artificial intelligence outputs that are responsive to the request. In particular, the artificial intelligence outputs can include computer code, terminal commands, outputs corresponding to terminal commands, website browsing actions, and outputs corresponding to running computer code (e.g., any output corresponding to the autonomous software agent utilizing the computer software composition tools 110).

As mentioned above, existing systems are inefficient. For example, existing systems provide code generation assistant features to assist a developer in completing their software tasks. However, these existing systems merely supplement developer work. In particular, existing systems require heavily involved guidance, prompting, monitoring, and the use of a developer’s device in order to supplement developer work. In other words, existing systems merely act as a co-pilot to a developer. Accordingly, existing systems suffer from computational inefficiencies of attempting to integrate a code development assistant into a developer’s workflow and often suffer from being prompted and re-prompted to yield satisfactory results (e.g., which results in wasted computational resources).

In addition to their inefficiency issues, existing systems are also inaccurate. More particularly, due to the standard paradigm of existing systems supplementing code development, existing systems are often incomplete or inadequate in generating complex and extensive computer code. Moreover, existing systems often supplement code development efforts but generate computer code that inaccurately addresses an intent (expressed by an input prompt) and/or that is operationally invalid, including syntactic errors, semantic errors, and/or logical errors.

In particular, existing systems may be able to generate computer code to supplement a developer’s task, however it is often difficult or impossible to follow/understand the thought process of existing code generation systems writing computer code. Often, existing code generation systems are a black box that receive instructions and output computer code (e.g., which results in difficulties understanding how the existing code generation system arrived at its answer). As such, modifying intermediate steps of a (supplementary) software coding task performed by existing code generation systems are often infeasible.

Relatedly, existing systems suffer from operational inflexibility. Because existing systems are limited to supplementing code development for cases expressly coded by engineers, these existing systems fail to adapt to creating new computer code, tackling complex non-trivial tasks, correctly understanding already generated computer code and/or effectively performing tests on computer code. Indeed, the inflexible nature of existing systems severely hampers the ability of existing systems to keep up with the taxing demands of software development from a holistic perspective. In other words, existing systems are stuck as operating as a co-pilot developer to merely supplement a software developer’s workflow.

In one or more embodiments, the autonomous software agent system 100 provides several improvements over conventional systems in relation to technical accuracy, computational efficiency, and operational flexibility. In contrast to existing systems, which require heavily involved guidance, prompting, monitoring, and the use of a developer’s device (in order to supplement developer work), the autonomous software agent system 100 deploys an autonomous software agent that operates as an independent virtual machine computing device.

In doing so, the autonomous software agent system 100 allows for an autonomous software agent to operate independently to solve non-trivial tasks, and it does not conflate or confuse context of other ongoing tasks. Specifically, the autonomous software agent system 100 silos/isolates autonomous software agents (e.g., to operate independently with fully featured computer software composition tools such as a shell tool, a browser tool, an integrated development environment, and/or a planner tool) such that the autonomous software agents can accurately perform their assigned software tasks without being bogged down by additional information.

In one or more embodiments, the autonomous software agent system 100 further improves upon technical inaccuracies. In contrast to existing systems, which are often incomplete or inadequate in generating complex and extensive computer code, the autonomous software agent system 100 deploys an autonomous software agent that uses an intelligent orchestration process to determine how to understand a relevant code repository/environment, how to generate artificial intelligence outputs (e.g., computer code) that matches a determined context, and how to choose between various artificial intelligence models to accomplish various software tasks. In some embodiments, the autonomous software agent system 100 allows a user computing device to configure an autonomous software agent environment and deploys the autonomous software agent to complete a software task, thus improving the technical accuracy of artificial intelligence agents performing software tasks (e.g., relative to existing systems).

In one or more embodiments, the autonomous software agent system 100 enables a user computing device to follow the work of an autonomous software agent as it performs a software coding task. For example, the autonomous software agent system 100 displays commands submitted by the autonomous software agent via a terminal, computer code being written by the autonomous software agent via an editor, and computer code being debugged by the autonomous software agent. As such, the autonomous software agent system 100 enables a user computing device to more accurately understand the manner in which an autonomous software agent arrived at a result (e.g., the user computing device can follow the autonomous software agent in real-time).

Relatedly, the autonomous software agent system 100 also improves computational efficiency of software tasks by enabling options for a user computing device to follow an autonomous software agent executing a software task. In particular, as mentioned, the autonomous software agent can operate independently, and in some instances, a user computing device can intervene or understand the steps/thought processes of an autonomous software agent by following the autonomous software agent as it switches between using different computer software composition tools. In particular, a user computing device can follow an autonomous software agent as it switches between a shell tool, a browser tool, an integrated development environment, and/or a planner tool to execute a software task. In doing so, the autonomous software agent system 100 saves computational resources and time as a user computing device can more efficiently understand the process of an autonomous software agent (e.g., as it performs a task or after it performs a task) and the user computing device can intervene and one or more points in the development session to aid/assist an autonomous software agent.

Furthermore, the autonomous software agent system 100 improves computational efficiency by enabling a user computing device to continue to delegate entire non-trivial software coding tasks to the autonomous software agent while the autonomous software agent is already working completely asynchronously. As the autonomous software agent is executing a software coding task, a user computing device can delegate multiple additional autonomous software agents to perform additional software tasks. Thus, the autonomous software agent system 100 enables large scale parallelization of tasks.

In one or more embodiments, the autonomous software agent system 100 further improves upon operational inflexibilities. In contrast to existing systems, which are rigidly tied to code supplementation, the autonomous software agent system 100 deploys an autonomous software agent that operates within an independent virtual machine computing environment and further allows a user computing device to monitor/modify the progress of the autonomous software agent (if so desired). Moreover, because the autonomous software agent system 100 deploys an autonomous software agent that is provided with various development box tools (e.g., browser, planner, editor, and shell), the autonomous software agent acts as an advanced reasoning tool to complete non-trivial tasks. Accordingly, the autonomous software agent system 100 enhances the flexibility of operations in performing code generation tasks relative to existing systems.

Furthermore, providing the autonomous software agent system 100 with an IDE, shell interface, and browser within its own virtual machine further improves deterministic execution and reproducibility. Conventional development systems frequently suffer from dependency mismatches, configuration drift, and non-reproducible builds. By maintaining controlled environment configurations and dependency states within the virtual machine, the autonomous software agent system 100 ensures consistent runtime conditions, reproducible build artifacts, and repeatable testing outcomes.

Additionally, the coordinated integration of the virtual machine, IDE, shell interface, planner tool, and browser tool reduces cascading error propagation during automated code generation. For example, the planner tool monitors intermediate results and initiates selective rollback via virtual machine snapshotting, localized file modification within the IDE, and controlled shell-level command execution. This minimizes system-wide reinitialization events and reduces computational overhead compared to conventional automated systems lacking structured planning and isolation.

FIG. 2 illustrates the autonomous software agent system 100 deploying an autonomous software agent with access to a shell tool, a browser tool, an integrated development environment, and a planner tool in accordance with one or more embodiments. For example, FIG. 2 shows the autonomous software agent system 100 accessing a variety of computer software composition tools to execute a software task. In particular, FIG. 2 shows the autonomous software agent system 100 receiving a request 200 that includes a software task 202.

As mentioned above, the autonomous software agent system 100 receives the request 200 from a user of a computing device (e.g., a user computing device). In one or more embodiments, a user computing device refers to a device that interacts with computer systems, accesses code repositories, writes computer code, and runs applications based on instructions received from the user.

In some embodiments, a user computing device is part of a centralized computer code development platform with a plurality of additional users (e.g., corresponding to additional user computing devices). Moreover, in some embodiments, the centralized computer code development platform is also accessed by an autonomous software agent (e.g., via access permissions granted to the autonomous software agent by one or more users of the centralized computer code development platform).

In one or more embodiments, the centralized computer code development platform refers to a collaborative software environment where software developer computing devices (e.g., user computing devices) access, build, test, and deploy computer code software for a unified platform. In particular, the centralized computer code development platform can include source code, code repositories (e.g., code libraries), and code documentation. Moreover, when a software developer computing device adds/modifies computer code in the centralized computer code development platform, the software developer computing device can track changes made to the code (e.g., leave comments).

As mentioned above, the autonomous software agent system 100 receives the request 200. In some embodiments, the autonomous software agent system 100 receives the request 200 via an application programming interface (API). In particular, a user computing device can build custom workflows using an API of the autonomous software agent system 100 and programmatically assign tasks for the autonomous software agent system 100 to execute. Further, with the API, user computing devices can essentially plug in the autonomous software agent system 100 to any of their software development tools and internal tools.

As shown in FIG. 2, the autonomous software agent system 100 performs an act 206 of deploying an autonomous software agent that operates within an independent virtual machine computing environment 204. In one or more embodiments, the independent virtual machine computing environment 204 refers to a software-based simulation that independently runs its own operating system and applications as a standalone machine. For example, a virtual machine computing environment 204 refers to a software-implemented computational environment that emulates a physical computing system and provides an isolated, executable runtime environment for code generation, execution, testing, modification, or orchestration by the autonomous software agent system 100. In one or more embodiments, the virtual machine computing environment 204 may operate as a system-level virtualization layer (e.g., hypervisor-based virtual machine), an operating system–level container, a language runtime virtual machine, or a custom execution sandbox, and may be dynamically provisioned, configured, and decommissioned under control of the virtual machine computing environment 204. Thus, a deployed autonomous software agent independently leverages its own independent computing environment.

In some embodiments, the autonomous software agent system 100 deploys an autonomous software agent in response to being triggered by a code editor. In particular, from another code editor/integrated development environment (IDE), users of computing devices can assign tasks to the autonomous software agent system 100 directly from their code editor/IDE (e.g., the autonomous software agent system 100 receives the request 200 from the code editor of a user).

In some embodiments, the autonomous software agent system 100 can deploy an autonomous software agent in response to being tagged/mentioned in a third-party messaging application (e.g., between a plurality of users). In particular, user computing devices can tag the autonomous software agent system 100 directly from conversations they are having with colleagues in the third-party messaging application. Furthermore, the autonomous software agent system 100 will reply directly in the messaging thread and any user that is part of the third-party messaging application can submit instructions to the autonomous software agent system 100. In other words, the autonomous software agent system 100 receives the request 200 from a third-party messaging application between a plurality of users.

In one or more embodiments, the software task 202 refers to a defined unit of work in a software project to be planned, assigned, executed and/or completed. For example, the software task 202 refers to a specific software component for the autonomous software agent system 100 to build, change, fix, and/or maintain based on requirements of the request 200. In other words, the software task 202 refers to a discrete, actionable piece of work that contributes to the development, maintenance, or improvement of a software system. More specifically, a software task refers to a defined computational objective, instruction set, or problem specification that can be satisfied through the generation, modification, execution, analysis, or orchestration of computer-executable code by an artificial intelligence (AI) code-writing agent.

A software task may be expressed in natural language, structured prompts, formal specifications, source code fragments, test cases, API definitions, configuration files, user stories, or any combination thereof. In one or more embodiments, a software task defines one or more functional, logical, structural, or performance requirements that constrain or guide code generation or transformation. For example, a software task may include, without limitation: generating source code implementing specified functionality; translating code between programming languages or frameworks; completing partial code segments; refactoring, optimizing, or modifying existing code; debugging code based on error messages, stack traces, or failing tests; generating unit tests, integration tests, or documentation; constructing data pipelines, scripts, or infrastructure definitions; performing static or dynamic analysis and producing corrective modifications; or orchestrating multi-step development workflows involving code synthesis and validation.

In one or more embodiments, a software task may further include associated constraints such as target programming language, runtime environment, library dependencies, security policies, performance thresholds, coding standards, or interface requirements. In some embodiments, a software task may be decomposed into subtasks, iteratively refined, validated against automated test harnesses, or dynamically modified based on intermediate execution results. The autonomous software agent system 100 may autonomously interpret, prioritize, sequence, and execute one or more software tasks within a broader development objective. Unless expressly limited, a software task encompasses any machine-interpretable or human-specified objective that can be fulfilled, in whole or in part, through automated code generation or code manipulation.

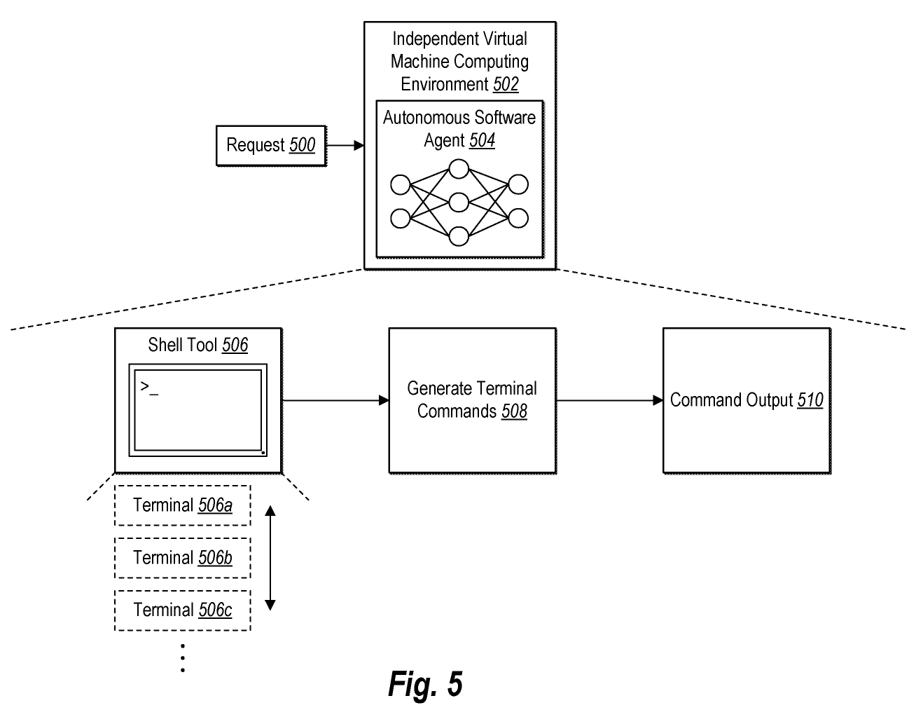

As shown in FIG. 2, the autonomous software agent system 100 provides a shell tool 208, a browser tool 210, an integrated development environment 212 (editor tool), and/or a planner tool 214 to an autonomous software agent deployed to execute the request 200. In some embodiments, the shell tool 208 (or simply shell) refers to a text-based tool where the autonomous software agent system 100 can input commands that interact directly with a computer’s operating system. For example, a shell tool 208 refers to an interface layer that mediates interaction between an artificial intelligence (AI) agent and an underlying execution environment, computing system, development environment, or virtualized runtime. The shell tool 208 provides a structured command, control, and input/output framework through which the autonomous software agent system 100 issues instructions, receives responses, and orchestrates software development operations. A shell tool 208 may comprise a command-line interpreter, application programming interface (API) interface, remote procedure call (RPC) interface, messaging interface, terminal emulator, container interface, virtual machine interface, or any combination thereof. The shell tool 208 abstracts underlying system resources—including file systems, process control, compilers, interpreters, debuggers, network interfaces, and package managers—and presents a controllable operational surface to the autonomous software agent system 100. Additional details regarding use of the shell tool 208 are given below in FIG. 5.

As used herein, a browser tool 210 (or simply browser) refers to a software component executing within an independent virtual machine computing environment 204 and configured to retrieve, render, interpret, and interact with network-accessible resources on behalf of an autonomous software agent system 100. A browser tool 210 operates as a controlled network interaction interface within the independent virtual machine computing environment 204 and provides the autonomous software agent system 100 with programmatic access to web content, application interfaces, documentation repositories, APIs, development resources, and other remote computing services. A browser tool 210 may implement one or more communication protocols, including HTTP, HTTPS, WebSocket, or other network transport protocols.

In the context of the autonomous software agent system 100, a browser tool 210 may be configured to retrieve web pages, API responses, source code repositories, software documentation, or structured data from remote systems; render and parse markup languages including HTML, XML, Markdown, and script-generated content; execute client-side scripts in a sandboxed runtime; extract structured representations of document object models (DOMs), metadata, form fields, and interactive elements; submit forms, authenticate sessions, manage cookies or tokens, and maintain session state; download, upload, or modify remote resources under controlled permissions; provide machine-readable representations of rendered content to the autonomous software agent system 100 for reasoning and code generation; and enforce network policies, domain restrictions, rate limits, and security guardrails.

In some embodiments, a browser tool 210 is configured to expose structured outputs—such as DOM trees, accessibility trees, rendered text, event traces, console logs, or network traces—rather than or in addition to graphical output. A browser tool 210 may operate in headless mode and may be programmatically controlled via an automation interface.

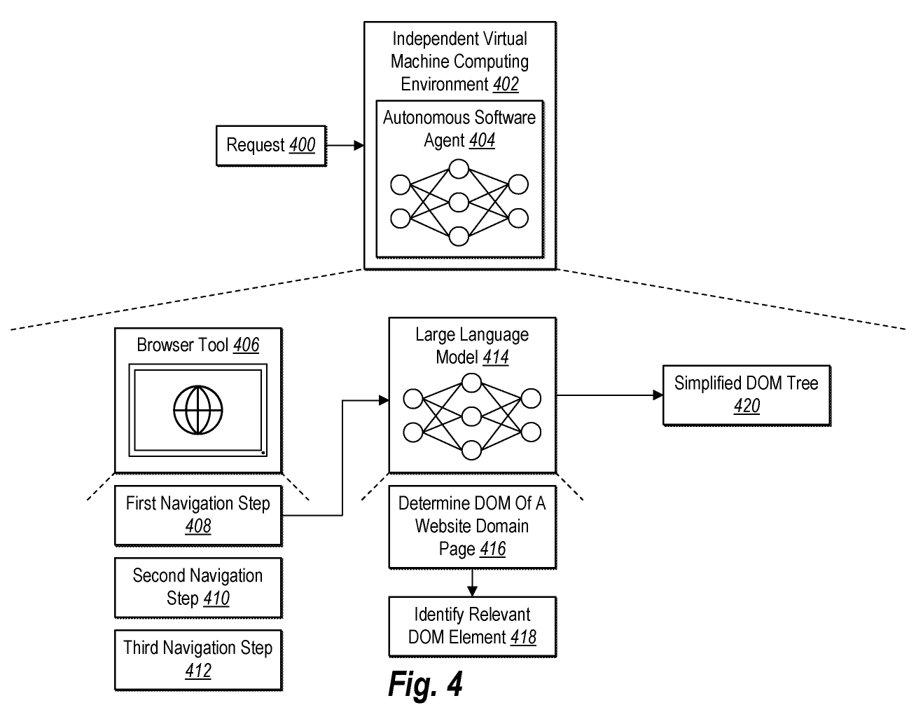

A browser tool 210, as part of the independent virtual machine computing environment 204, is isolated from a host computing system and subject to resource constraints, execution monitoring, and security policies defined by the independent virtual machine computing environment 204. This isolation permits the autonomous software agent system 100 to perform research, dependency resolution, API inspection, automated testing of web applications, or code retrieval without exposing the host environment to uncontrolled network interactions. Unless expressly limited, a browser tool 210 encompasses any web client, headless browsing engine, embedded rendering engine, automated browsing framework, or network-interaction module configured to retrieve and interact with remote content within a virtualized execution environment controlled by the autonomous software agent system 100. Additional details for a browser tool 210 are given below in FIG. 4.

In some embodiments, the integrated development environment (IDE) 212 refers to an editor tool to write computer code and computer tests. In some embodiments, the integrated development environment 212 is a software application that brings together software tools for software development. In particular, the integrated development environment 212 refers to a software application that combines essential software development features (e.g., coding, debugging, testing, and deployment) to increase the efficiency of completing software projects. The IDE 212 may further maintain structured representations of a project state, including file hierarchies, dependency graphs, abstract syntax trees (ASTs), symbol tables, error diagnostics, execution traces, and build artifacts. In the context of the autonomous software agent system 100, the IDE 212 is configured to one or more software tasks; create, edit, refactor, or delete source files; invoke compilation or interpretation processes; execute unit tests or integration tests; surface compiler diagnostics and runtime errors; perform automated refactoring or formatting; manage branches and commits within a version control system; and return structured, machine-readable feedback to the autonomous software agent system 100 to enable iterative reasoning and code refinement.

In some embodiments, the integrated development environment 212 is a fully featured application that allows an autonomous software agent to write, test, and debug code without switching between different software applications. For example, the integrated development environment can include a code editor (e.g., syntax highlighting, code completion, etc.), a compiler/interpreter (e.g., converts source code into executable program code), a debugger (e.g., to find and fix computer code errors), a file browser (e.g., to navigate through files in a centralized development platform), version control (e.g., commit, push, pull, merge computer code in a code repository), and a terminal (e.g., direct command execution to run scripts or access computer system utilities).

In some embodiments, the autonomous software agent system 100 provides a code editor to the autonomous software agent, where the code editor is a sub-component of the integrated development environment. In other words, in some embodiments, the autonomous software agent system 100 provides a fully featured IDE that merges the functionalities of a code editor and the shell tool 208.

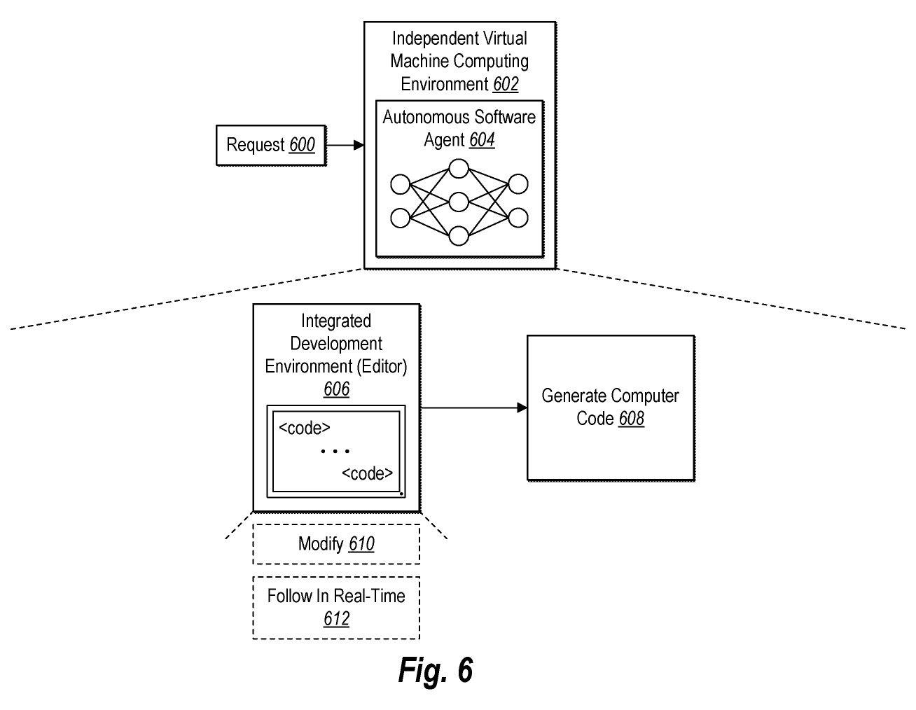

Accordingly, the autonomous software agent system 100 provides the autonomous software agent with its own IDE (e.g., independent of a computer code development environment of a user computing device that submitted the request 200) to perform software coding tasks. In other words, the autonomous software agent has full access to the integrated development environment 212, which enables the autonomous software agent to complete complex software development tasks. Addition details for the IDE are given below in FIG. 6.

In one or more embodiments, the planner tool 214 refers to an artificial intelligence model that analyzes the request 200 and plans how to execute the request 200. In particular, the planner tool 214 breaks down the request 200 to manageable tasks and generates an artificial intelligence plan. In some embodiments, the autonomous software agent system 100 utilizes the planner tool 214 to generate the artificial intelligence plan and presents the artificial intelligence plan to a user computing device to modify or confirm one or more aspects in the artificial intelligence plan.

More specifically, that planner tool is configured to analyze one or more input objectives, user intents, or software task specifications and to generate structured, multi-step plans that guide operation of an autonomous software agent system 100 in performing code generation, modification, testing, analysis, or orchestration tasks. The planner tool 214 may be implemented using one or more underlying computational models, including but not limited to large language models (LLMs), transformer-based neural networks, sequence-to-sequence models, reinforcement learning models, probabilistic graphical models, symbolic reasoning engines, constraint solvers, heuristic search algorithms, or hybrid neuro-symbolic architectures. In one or more embodiments, planner tool 214 leverages a generative pretrained transformer model, including a code-capable language model, to infer task structure, identify implicit constraints, and predict ordered action sequences based on prior training across natural language corpora, source code repositories, execution traces, and software development workflows.

In one or more embodiments, the planner tool 214 is configured to decompose complex objectives into a sequence of actionable subtasks, determine dependencies and ordering among subtasks, and construct an execution plan consumable by downstream components such as code generation modules, debugging modules, the browser tool 210, the shell tool 208, IDE 212, testing frameworks, or other tool interfaces. The generated plan may comprise, without limitation, a hierarchical task tree, directed acyclic graph (DAG), ordered action list, state machine representation, or other structured plan representation including defined inputs, outputs, preconditions, postconditions, and success criteria.

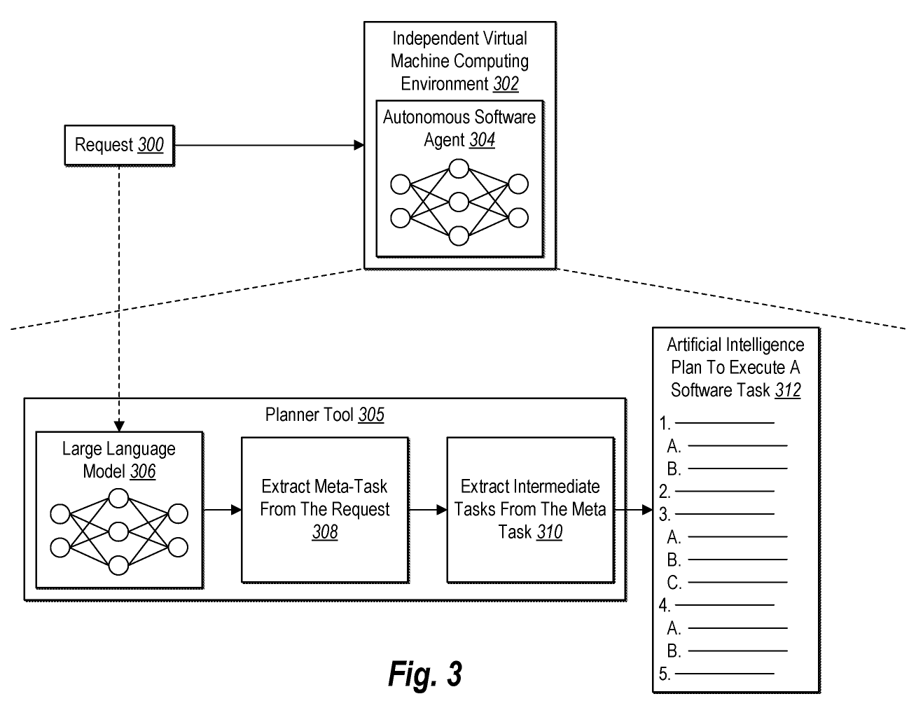

In certain embodiments, planner tool 214 employs prompt-based reasoning, chain-of-thought inference, tree search, beam search, Monte Carlo sampling, reinforcement learning–based policy selection, or combinations thereof to evaluate multiple candidate plans and select or refine a plan according to defined optimization metrics. The planner tool 214 may further incorporate memory mechanisms, including contextual embeddings, vector databases, episodic execution logs, or persistent state representations, to inform plan generation based on prior interactions or historical outcomes. The planner tool 214 may monitor intermediate execution results and dynamically revise, re-order, expand, or prune subtasks based on feedback including compiler diagnostics, runtime errors, test failures, environmental changes, or external tool responses. In this manner, planner tool 214 supports iterative, adaptive, reactive, or predictive planning strategies. In some embodiments, the planner tool 214 operates as a distinct module that communicates with other components of autonomous software agent system 100 via structured messages, application programming interfaces (APIs), or message-passing protocols. Additional details regarding the planner tool 214 are given below in FIG. 3.

In one or more embodiments, the autonomous software agent system 100 orchestrates an execution of the software task 202 by utilizing the autonomous software agent to switch between different tools. In particular, the autonomous software agent system 100 utilizes the planner tool 214 to generate an artificial intelligence plan, utilizes the shell tool 208 to submit terminal commands, utilizes the browser tool 210 to obtain website domain information, utilizes the integrated development environment 212 to write computer code. In other words, the autonomous software agent system 100 switches between the tools to accurately and efficiently accomplish the request 200 that indicates the software task 202.

More specifically, in one or more embodiments, the autonomous software agent system 100 is configured to automatically (e.g., without further user instructions other than the prompt defining the software task) perform an assigned software task using coordinated interaction among planner tool 214, browser tool 210, an integrated development environment (IDE) 212, a shell tool 208, and an independent virtual machine computing environment 204. For example, upon receiving a software task—expressed in natural language, structured specification, source code fragment, test case, or other machine-interpretable format—the autonomous software agent system 100 provides the software task to planner tool 214. The planner tool 214 analyzes the objective and generates a structured execution plan comprising an ordered set of subtasks, dependency relationships, required tools, expected outputs, and validation criteria. The execution plan may define actions such as retrieving documentation, generating source code, creating files, compiling code, executing tests, debugging failures, refactoring modules, or deploying artifacts. The autonomous software agent system 100 executes the structured plan within the independent virtual machine computing environment 204. Where plan steps require external information or dependency retrieval, the autonomous software agent system 100 invokes the browser tool 210 within the independent virtual machine computing environment 204. The autonomous software agent system 100 uses the browser tool 210 to retrieve and parse remote documentation, API specifications, repositories, or other network-accessible resources and returns structured, machine-readable representations to autonomous software agent system 100 for reasoning and code synthesis.

For code authoring and modification operations, the autonomous software agent system 100 interacts with the IDE 212. The IDE 212 enables creation, editing, refactoring, and organization of source files, as well as invocation of compilers, interpreters, build systems, static analysis tools, and test frameworks. The IDE 212 provides structured diagnostics, including syntax errors, semantic warnings, dependency conflicts, and build logs, which are returned to autonomous software agent system 100. Where system-level commands are required, autonomous software agent system 100 issues instructions through the shell tool 208 executing within the independent virtual machine computing environment 204. The shell tool 208 enables file system manipulation, dependency installation, build execution, test invocation, process control, and other operating system–level operations. Structured outputs including exit codes, logs, and error streams are returned to autonomous software agent system 100.

The planner tool 214, in one or more implementations, monitors intermediate results generated by the IDE 212, browser tool 210, and shell tool 208, and compares those results against plan-defined success criteria. If discrepancies, failures, or unexpected states are detected, the planner tool 214 automatically revises the execution plan, generates corrective subtasks, reorders actions, or initiates debugging procedures. This iterative loop continues until the software task satisfies defined completion conditions or termination criteria. In this manner, autonomous software agent system 100 autonomously decomposes, executes, validates, and refines development actions within the independent virtual machine computing environment 204 using coordinated tool invocation and structured feedback processing. The integration of planner tool 214, browser tool 210, the IDE 218, the shell tool 208, and the independent virtual machine computing environment 204 enables end-to-end automated software development, testing, and validation without direct human intervention.

FIG. 3 illustrates the autonomous software agent system 100 utilizing a planner tool to generate an artificial intelligence plan in accordance with one or more embodiments. In particular, FIG. 3 shows the autonomous software agent system 100 accessing/receiving a request 300 (e.g., from a user computing device). Furthermore, FIG. 3 shows the autonomous software agent system 100 deploying an autonomous software agent 304 to operate within an independent virtual machine computing environment 302.

As mentioned, the autonomous software agent system 100 utilizes the planner tool 305 to improve the efficiency and accuracy of executing a software task from the request 300. In some embodiments, the autonomous software agent system 100 utilizes the planner tool 305 to generate a running “to do” list. In particular, the autonomous software agent system 100 can use the planner tool 305 to break down (e.g., decompose) the request 300 and to infer one or more intents of the request 300. In one or more embodiments, the autonomous software agent system 100 utilizes the planner tool 305 to assist a user in visualizing how the autonomous software agent 304 (e.g., deployed by the autonomous software agent system 100) plans and thinks through solving a problem (e.g., as indicated in the request 300).

As shown in FIG. 3, the autonomous software agent system 100 utilizes a large language model 306 (e.g., a planning model) to analyze the request 300. In one or more embodiments, the autonomous software agent system 100 utilizes the large language model 306 that leverages retrieval-augmented generation (RAG) to generate an artificial intelligence plan 312. In some embodiments, retrieval-augmented generation refers to retrieving relevant information from an external database or knowledge source in context of the request 300. In particular, the autonomous software agent system 100 can utilize RAG (e.g., which includes using the large language model 306) to generate a response (e.g., the artificial intelligence plan 312) by leveraging both the retrieved information (from an external source) and its own internal knowledge base. In particular, the autonomous software agent system 100 leverages RAG, which includes an input query, information retrieval, and response generation to perform a task of generating the artificial intelligence plan 312.

As further shown in FIG. 3, the autonomous software agent system 100 further utilizes the large language model 306 to perform an act 308 of extracting a meta-task from the request 300. Moreover, as shown, the autonomous software agent system 100 performs an act 310 of extracting intermediate tasks (e.g., sub-tasks) from the meta-task. In one or more embodiments, the autonomous software agent system 100 analyzes the request 300, determines an intent (e.g., a meta-task) of the request 300, and determines discrete sub-tasks (e.g., intermediate tasks).

In particular, the autonomous software agent system 100 can prompt the large language model 306 to divide the request 300 into manageable and discrete sub-portions. In other words, the autonomous software agent system 100 prompts the large language model 306 to identify tasks that point to different code repositories, data sources, and systems as being their own sub-task. In particular, the autonomous software agent system 100 can prompt the large language model 306 and include example breakdowns of example requests.

Moreover, in some embodiments, the autonomous software agent system 100 trains the large language model 306 with example datasets for breaking down a request into a meta-task and a plurality of sub-tasks. In particular, the autonomous software agent system 100 trains the large language model 306 by having it generate a predicted artificial intelligence plan and compares the prediction to a ground truth reference.

As shown in FIG. 3, the autonomous software agent system 100 utilizes the large language model 306 to generate an artificial intelligence plan 312 to execute a software task. In particular, the autonomous software agent system 100 generates the artificial intelligence plan 312 which includes a meta-task extracted from the request 300 and intermediate tasks extracted from the meta-task. In one or more embodiments, the autonomous software agent system 100 provides the artificial intelligence plan 312 to a graphical user interface of a computing device. In particular, the autonomous software agent system 100 provides the artificial intelligence plan 312 to receive approval or modification from a user computing device.

For example, the autonomous software agent system 100 can receive modifications to one or more tasks/sub-tasks and/or the meta-task extracted from the request. In some instances, the autonomous software agent system 100 can receive additional context or additional files to further customize the artificial intelligence plan 312. In some embodiments, the autonomous software agent system 100 receives one or more modifications to the artificial intelligence plan 312 and generates a modified artificial intelligence plan.

Further, the autonomous software agent system 100 can prompt a user computing device to provide approval of the modified artificial intelligence plan. In response to receiving approval of an (updated) artificial intelligence plan, the autonomous software agent system 100 deploys the autonomous software agent 304 to execute the request 300 according to the artificial intelligence plan.

FIG. 4 illustrates the autonomous software agent system 100 utilizing a browser tool to perform one or more actions responsive to a request to execute a software task in accordance with one or more embodiments. For example, FIG. 4 shows the autonomous software agent system 100 accessing/receiving a request 400. In particular, FIG. 4 shows the autonomous software agent system 100 deploying an autonomous software agent 404 to operate within an independent virtual machine computing environment 402.

As shown in FIG. 4, the autonomous software agent system 100 utilizes the autonomous software agent 404 to access a browser tool 406. As mentioned, the autonomous software agent system 100 utilizes the browser tool 406 to browse documentation on one or more website domain pages, test web applications (e.g., local applications), download information, upload information, etc. In particular, FIG. 4 shows the autonomous software agent system 100 utilizing the browser tool 406 to perform a first navigation step 408, a second navigation step 410, and a third navigation step 412.

In one or more embodiments, a website domain page refers to a webpage hosted under a domain name that serves as an entry point of a website and is identified by a URL. For example, a website domain page refers to a digital webpage associated with a domain name that has a unique URL and contains structured content (e.g., text, images, links, and other media). In particular, a website domain page is part of a larger website hierarchy. To illustrate, a website hierarchy includes a homepage, subpages, and subdomain pages. In some embodiments, a plurality of website domain pages is associated with an entity.

In one or more embodiments, the autonomous software agent system 100 utilizes the browser tool 406 to obtain information from a website domain page. In some embodiments, the autonomous software agent system 100 determines whether a particular portion of a website domain page is relevant to the request 400 to execute a software task. As shown in FIG. 4, the autonomous software agent system 100 utilizes a large language model 414 (e.g., a website relevance model) to determine the relevance of a sub-portion, portion, or entire website domain page.

In other words, website domain pages contain an excessive amount of information. In particular, large language models are typically bogged down with processing all elements within a website domain page. Thus, the autonomous software agent system 100 distills a website domain page structure (e.g., utilizing the large language model 414) and provides a simplified structure (e.g., HTML) to the autonomous software agent 404 for further processing. In doing so, the autonomous software agent system 100 enables the autonomous software agent 404 to process a large amount of data from website domain pages without performance degradation.

As shown in FIG. 4, the autonomous software agent system 100 utilizes the large language model 414 to perform an act 416 of determining a document object model (DOM) of a website domain page. In particular, the autonomous software agent system 100 passes a website domain page to the large language model 414 to determine a document object model of the website domain page.

In one or more embodiments, a document object model refers to a structured, hierarchical representation of a webpage’s content that defines how HTML elements are programmatically accessed, modified, and analyzed. In one or more embodiments, the autonomous software agent system 100 detects a document object model object within a website domain page. For example, the DOM includes a representation of structure, content and properties within a website domain page. For instance, a user of a website domain page interacts with and manipulates a DOM object. Further, in some embodiments the DOM includes HTML or XML format. Accordingly, the DOM includes references to specific elements or nodes within the website domain page. To illustrate, DOM objects are part of a DOM tree structure, where each node of the DOM tree structure corresponds to a specific element in a website domain page.

As further shown in FIG. 4, the autonomous software agent system 100 utilizes the large language model 414 to perform an act 418 of identifying relevant document object model elements (e.g., DOM elements). In particular, the autonomous software agent system 100 prompts the large language model 414 to identify relevant DOM elements in context of the request 400. In other words, the autonomous software agent system 100 utilizes the large language model 414 to distill a website domain page into a relevant set of elements for the request 400.

As shown in FIG. 4, the autonomous software agent system 100 utilizes the large language model 414 to generate a simplified DOM tree 420 (e.g., a simplified document object model tree). As mentioned above, in some instances, a website domain page contains a large amount of data that can potentially bog down computational processes. As such, the autonomous software agent system 100 utilizes the large language model 414 to extract the most salient/relevant elements from a website domain page (e.g., being browsed via the browser tool 406) and generates the simplified DOM tree 420.

In one or more embodiments, the simplified DOM tree 420 refers to distilled document object model structured and/or a distilled hierarchical representation of a webpage’s content. In particular, the simplified DOM tree 420 includes a hierarchy of nodes and elements from the website domain page that are relevant to the request 400. In other words, the simplified DOM tree 420 contains fewer website domain page elements relative to an initially determined DOM tree from the website domain page.

In some embodiments, the autonomous software agent system 100 receives a selection of a browser feature and opens/launches an interactive browser of the autonomous software agent 404. In particular, the autonomous software agent system 100 causes a graphical user interface (e.g., of a user computing device) to show browser activity (e.g., navigation steps) of the autonomous software agent 404 utilizing the browser tool 406 while independently performing the software task. Accordingly, the user computing device (e.g., via the graphical user interface) can intervene (e.g., take over) the autonomous software agent’s browser and push a software task in a different direction.

FIG. 5 illustrates the autonomous software agent system 100 utilizing a shell tool to generate one or more terminal commands in accordance with one or more embodiments. For example, FIG. 5 shows the autonomous software agent system 100 accessing/receiving a request 500 and deploying an autonomous software agent 504 in response to the request 500. In particular, FIG. 5 shows the autonomous software agent system 100 deploying the autonomous software agent 504 to operate within an independent virtual machine computing environment 502.

Additionally, FIG. 5 shows the autonomous software agent system 100 providing a shell tool 506 to the autonomous software agent 504. In one or more embodiments, the shell tool 506 refers to one or more terminals (e.g., one or more terminal windows). As shown in FIG. 5, the shell tool 506 can include a first terminal 506a, a second terminal 506b, and a third terminal 506c. In particular, the autonomous software agent system 100 deploys the autonomous software agent 504 that can create new terminal windows or switch to different terminal windows, or delete terminals (e.g., which is how an autonomous software agent 504 can run multiple processes at once). For relatively long commands, the autonomous software agent system 100 can use the autonomous software agent 504 to shift its attention away from the long-running command and multitask in parallel (e.g., via the shell tool 506).

In some embodiments, the shell tool 506 is a text-based application where the autonomous software agent 504 can input commands that interact directly with a computer’s operating system. In particular, the autonomous software agent system 100 spins up the autonomous software agent 504 that includes a shell application and in the shell application there are different terminals. As mentioned, where each terminal is like a single terminal window, the autonomous software agent system 100 (e.g., via the autonomous software agent 504) has the ability to create new terminals, switch to different terminal windows or delete terminals.

Furthermore, FIG. 5 shows the autonomous software agent system 100 performing an act 508 of utilizing the autonomous software agent 504 to generate terminal commands. In one or more embodiments, a terminal command refers to refers to text instructions to instruct a computer’s operating system. In particular, a terminal command refers to one-line instructions that typically call upon existing programs of an operating system.

In some embodiments, a terminal command refers to text-based instructions submitted/inputted into a terminal (e.g., the terminal is an interface that allows computing devices such as the autonomous software agent 504 to interact with a computer system’s underlying operating system or run scripts and programs directly). To illustrate, terminal commands can include file and directory navigation, file operations, viewing file contents, searching and filtering, processes and systems in an operating system, determining permissions and ownerships in an operating system, and networking.

Moreover, FIG. 5 shows the autonomous software agent system 100 generating command outputs 510. In one or more embodiments, command outputs refer to outputs that corresponds with terminal commands submitted via the shell tool 506. To illustrate, a command output can include an absolute path (e.g., in response to a command to determine a location), tabular text (e.g., in response to a command to list files), raw file text (e.g., in response to a command to print file contents), an interactive viewer (e.g., in response to a command to provide a paged output), an output pattern (e.g., in response to a command to search/filter files in an operating system), and a file path (e.g., in response to a command to locate files).

Accordingly, FIG. 5 illustrates the autonomous software agent system 100 utilizing the autonomous software agent 504 to execute a software task (e.g., indicated by the request 500) by using the shell tool 506. In particular, the autonomous software agent system 100 determine a plurality of sub-tasks for a meta-task indicated in the request 500, generates an artificial intelligence plan, and utilizes the shell tool 506 to execute one or more of the sub-tasks (e.g., by submitting terminal commands).

In some embodiments, the autonomous software agent system 100 receives a selection of a shell feature and opens/launches an interactive shell of the autonomous software agent 504. In particular, the autonomous software agent system 100 causes a graphical user interface (e.g., of a user computing device) to show shell activity (e.g., terminal commands or outputs corresponding to terminal commands) of the autonomous software agent 504 utilizing the shell tool 506 while independently performing the software task. Accordingly, the user computing device (e.g., via the graphical user interface) can intervene (e.g., take over) the autonomous software agent’s shell and push a software task in a different direction.

FIG. 6 illustrates the autonomous software agent system 100 utilizing an integrated development environment to generate or revise computer code in accordance with one or more embodiments. For example, FIG. 6 shows the autonomous software agent system 100 accessing/receiving a request 600 and deploying an autonomous software agent 604. In particular, FIG. 6 shows the autonomous software agent system 100 deploying the autonomous software agent 604 to operate within an independent virtual machine computing environment 602.

Moreover, FIG. 6 shows the autonomous software agent system 100 providing an integrated development environment 606 (IDE tool) to the autonomous software agent 604. In one or more embodiments, the integrated development environment 606 of the autonomous software agent 604 includes an editor (e.g., in some embodiments, the autonomous software agent 604 utilizes multiple editor tabs which represent open files in an editor area of the IDE for writing/editing computer code). In particular, the editor corresponds to an open file.

As mentioned above, the autonomous software agent has access to its own editor. In some embodiments, an editor refers to a software program or tool for writing or modifying computer code. In particular, an editor streamlines a computer code writing process by providing syntax highlighting, auto-completion, and error detection. For example, the editor provides color-coding for keywords, variables, functions, and other code elements. Further, for auto-completion, the editor suggests completions for variables, methods, classes, and functions.

As mentioned, an editor can correspond to an opened file, such as a project file. In some embodiments, project files refer to a set of files and resources organized together to represent a specific software coding task (e.g., project). For example, the project files can include source code (e.g., program code written in a specific programming language), configurations (e.g., settings defining how a project is built, compiled, and executed), dependencies (e.g., external libraries), libraries, assets, and other components required to complete a software coding task.

As shown in FIG. 6, the autonomous software agent system 100 utilizes the integrated development environment 606 to perform an act 608 of generating computer code. In some embodiments, computer code includes a set of instructions written in a programming language that a computing device can interpret and execute to perform a specific task. In particular, computer code includes a series of statements and functions that execute specific operations. Further, computer code includes statements written in specific syntax and translatable into machine code to be executed by a computing device.

Further, computer code can include function code and test code. In some embodiments, function code refers to a set of instructions written in a programming language that a computing device can interpret and execute to perform a specific task. Function code can include a series of statements and functions that define specific operations or processes performed by a computer upon execution of the code. In some cases, function code includes statements written in specific syntax and translatable into machine code to be executed by a computing device for performing one or more processes of an overall intent.

In some embodiments, test code refers to computer code that defines a function test for function code. For example, text code can include one or more code segments for determining that the function code satisfies an intent query. In some cases, the autonomous software agent system 100 utilizes test code to test function code. For example, the autonomous software agent system 100 generates the test code that includes computer code for testing whether the output of function code satisfies an intent query. In some embodiments, test code can also test for different types of errors (e.g., syntax errors and logic errors) and/or for hazardous or harmful function code.

In some embodiments, the computer code includes executable program code which refers to a set of instructions that a computing device can directly execute. In particular, executable program code includes machine-readable instructions that result from compiling high-level programming languages. In other words, executable program code refers to a final output for a software development process created by compiling source code.

As noted above, in one or more embodiments, the autonomous software agent system 100 provides actions performed by the autonomous software agent 604 to a graphical user interface of a user (e.g., a user computing device). In particular, in context of the integrated development environment 606, the autonomous software agent system 100 can provide to a graphical user interface real-time actions and/or actions performed during a development session of the autonomous software agent 604 utilizing the integrated development environment 606.

FIG. 6 shows that in some embodiments, the autonomous software agent system 100 can receive an input selection 610 that relates to a user computing device indicating a desire to modify one or more inputs in the integrated development environment 606. Further, FIG. 6 shows that in some embodiments, the autonomous software agent system 100 can receive an input selection 612 to follow the autonomous software agent 604 (e.g., in real-time) as the autonomous software agent 604 executes a software task indicated by the request 600.

In some embodiments, the autonomous software agent system 100 provides for display the integrated development environment 606 that includes the above-mentioned editor tab. Further, in some instances, the autonomous software agent system 100 also provides a problems tab which lists errors, warnings, and information for computer code (in the editor tab) for a user to efficiently see errors in computer code or jump to problematic portions of computer code), an output tab (e.g., shows logs and messages from the IDE or extensions of the IDE to be notified of background activities like loading data onto a server or plugin operations), a debug console (e.g., allows for interactions with a program during debugging, such as viewing runtime logs, evaluating expressions, or inspecting variables), a terminal (e.g., a built-in shell/command-line interface for executing/submitting commands to a terminal, such as running scripts or installing packages), and a version control tab (e.g., provides information as to which devices submitted changes to a code repository and why the changes were submitted to a code repository).

FIG. 7 illustrates architectural details of the autonomous software agent system 100 using one or more machine learning models in accordance with one or more embodiments. In particular, the autonomous software agent system 100 deploys an autonomous software agent with a plurality of computer software composition tools, generates one or more artificial intelligence outputs responsive to a software task, and provides responses to prompts submitted via an interface.

As shown in FIG. 7, the autonomous software agent system 100 contains a client layer 700 (e.g., with a web browser 702, an IDE extension 704, and a command line interface client 706), a frontend layer 708 with a load balancer 710 (e.g., which is a system to distribute incoming traffic across multiple servers which optimizes efficiency), a web application 712 (e.g., a Devin web application that shows a chat interface and the fully featured software composition tools of the autonomous software agent), and static assets 714 (e.g., files that do not dynamically change based on user interactions, such as HTML files, CSS files, JavaScript files, images, etc.).

Moreover, FIG. 7 shows the autonomous software agent system 100 also contains backend services 716 with an API gateway 718 (e.g., which is a single entry point for managing and routing API requests from client devices to different microservices/backend systems), a version control integration 720 (e.g., a backend service application to track changes to code such as a connected code repository application part of a code repository management system), a code analysis service 722, a project management service 724 (e.g., a software system to track the development of various tasks that a software development team is working on), a core AI service 726 (e.g., artificial intelligence modules or tools to handle the use of machine learning models, natural language processing, and other artificial intelligence tasks), and an authentication service 728 (e.g., to check for valid authentication credentials).

In particular, the backend services 716 include applications that all communicate with the backend web-server of the autonomous software agent system 100, which performs the job of deploying autonomous software agents, and orchestrating/managing sessions (Devin sessions), as well as providing the APIs to display data about the autonomous software agent system 100 on various computing devices, generating artificial intelligence outputs, orchestrating the execution of software tasks by accessing a plurality of software composition tools, providing a plurality of interactive tools to a user computing device. In particular, the backend services 716 of the autonomous software agent system 100 manages the generation of artificial intelligence outputs for executing a software task of a development session.

For example, the backend services 716 performs the job of enabling request decomposition, artificial intelligence plan generation, terminal command generation, computer code generation, navigation actions, software task orchestration, and interactive tools of the autonomous software agent. In particular, the client layer 700, the frontend layer 708 and the backend services 716 are in consistent communication with one another to notify each service regarding any input received from a user computing device (e.g., via a chat interface and/or user intervention via interactive tools). Thus, this enables the autonomous software agent system 100 to immediately transfer that input/context to a deployed autonomous software agent.

Further, FIG. 7 shows a data layer 730 with object storage 732 (e.g., which is storage of unstructured data), a search index 734 (e.g., an index of one or more code repositories), a cache layer 736 (e.g., a layer that temporarily holds frequently accessed or recently computed data), and a primary database 738 (e.g., a central data store to hold application data). Moreover, FIG. 7 shows an AI layer 740 with a code understanding model 742, an LLM engine 744, and a code generation model 746. Moreover, FIG. 7 shows a development operations and monitoring layer 748 (e.g., with metrics collection 750, an alert system 751, and a logging system 752).

As shown in FIG. 7, the autonomous software agent system 100 utilizes the AI layer 740 to perform a variety of reasoning/generation tasks. In particular, the autonomous software agent system 100 accesses the AI layer 740 every time a code repository is connected or updated, or a new session is spun up (e.g., each time a new development box is activated). In order to enable the AI layer 740, the autonomous software agent system 100 provides various onboarding tools to a user computing device. In particular the onboarding tools allows a user to provide access to a code repository provider (e.g., a Gitprovider), select repositories, assign read access, and assign write access.

In some embodiments, the autonomous software agent system 100 prompts a user computing device for additional access permissions. In particular, the autonomous software agent system 100 can prompt the user for additional access permissions after generating a response to a prompt or during an autonomous software agent session. For example, the autonomous software agent system 100 determines during generating a response or executing software coding tasks that additional knowledge/permissions are needed to more thoroughly respond/perform a task.

As further shown in FIG. 7, the AI layer 740 of the autonomous software agent system 100 further includes the code understanding model 742. In particular, the code understanding model 742 analyzes computer code. In other words, the autonomous software agent system 100 seeks to understand the context and background of a code base/repository to generate an index of the code repository (e.g., to more effectively perform software coding tasks as a driver and not merely as a co-pilot).

In some embodiments, the autonomous software agent system 100 extracts contextual data from information provided by a user to generate an index using the code understanding model 742. To illustrate, the autonomous software agent system 100 parses through a code repository and generate abstraction summaries using the code understanding model 742 and one or more additional artificial intelligence models (e.g., such as the LLM engine).

Moreover, the autonomous software agent system 100 utilizes the AI layer 740 to enable AI-native features in a planner interface, a chat interface, or a configuration interface of an autonomous software agent. In particular, the autonomous software agent system 100 provides the AI-native features as options for a user computing device to activate during configuration or during interacting with the autonomous software agent system 100.

In some embodiments, the autonomous software agent system 100 uses the AI layer 740 to ingest data from a code base and further utilizes the code understanding model 742 to generate output predictions related to context of the code base. For example, the autonomous software agent system 100 connects to code repositories and creates knowledge inputs/suggestions based on processing the information in the code repository.

To illustrate, the autonomous software agent system 100 can read through documentation/specifications and distill that information into data that is relevant for the code understanding model 742 of the autonomous software agent system 100. In addition, after generating the index of the code repository, the autonomous software agent system 100 further stores the index in the data layer 730 and/or uses the development operations and monitoring layer 748 to monitor changes/thresholds related to the connected code repository. This allows the autonomous software agent system 100 to more effectively execute software coding tasks when deploying an autonomous software agent.

Moreover, after generating the index of the code repository, the autonomous software agent system 100 further generates response to prompts. In some embodiments, the autonomous software agent system 100 receives prompts from the frontend layer 708 submitted via an interface (or where the autonomous software agent system 100 intakes prompt, whether via the web application, a messaging application, or otherwise) and are sent to the backend services 716 of the autonomous software agent system 100, where the prompt is processed by the one or more artificial intelligence components (e.g., Devin’s brain).

As shown in FIG. 7, the autonomous software agent system 100 utilizes the client layer 700 to receive interactions. In particular, users can submit a prompt of a question regarding a current development session, past development session, a code repository, etc. via a Devin messaging application integration, an application programming interface call, or directly through a web browser application of the intelligent search interface. In some embodiments, the messaging application integration lets users prompt the autonomous software agent system 100 and to further create sessions by tagging an autonomous software agent in their team’s messaging server.

As just mentioned, the messaging application integration allows for development sessions to be created by tagging/mentioning an autonomous software agent. In some embodiments, the autonomous software agent system 100 receives from a third-party messaging application between a plurality of users, a mention that tags the autonomous software agent to execute the software task. Additionally, the autonomous software agent system 100 transmits the mention that tags the autonomous software agent to a virtual private cloud that hosts the independent virtual. This is shown in more detail below.

In some embodiments, as shown, the autonomous software agent system 100 utilizes the LLM engine 744 (e.g., a model that selects one or more large language models according to certain parameters/requirements) of an autonomous software agent to generate a response to a prompt. In particular, the autonomous software agent system 100 calls a first large language model for a first task (e.g., generating a first result for a prompt) and a second large language model for a second task (generating a second result for the prompt).

In one or more embodiments, the autonomous software agent system 100 utilizes the complex architectural design shown in FIG. 7. In particular, the autonomous software agent system 100 includes a natural language processing component (e.g., Devin’s Brain) that allows the autonomous software agent system 100 to understand natural language descriptions (e.g., the functionalities of desired software programs). In some embodiments, the autonomous software agent system 100 utilizes natural language processing to analyze natural language descriptions in a prompt and to extract key functionalities and requirements.

In one or more embodiments, the autonomous software agent system 100 generates an index of a code repository (e.g., accessible by an autonomous software agent) as described in Application No. 19/224,222 PROVIDING INTELLIGENT SEARCH FUNCTIONALITY OF A CODE REPOSITORY VIA AN AUTONOMOUS SOFTWARE AGENT which was filed on May 30^{th}, 2025, and is fully incorporated by reference herein.

As mentioned above, in some embodiments, the autonomous software agent system 100 generates a response to the prompt and uses the context from the response to deploy an autonomous software agent. In some embodiments, the autonomous software agent system 100 uses the autonomous software agent system 100 to spin up a development box, where each spun up development box contains knowledge and the autonomous software agent system from one session to another does not transfer the knowledge over to the next session. In some embodiments, knowledge is a form of “memory” that allows the autonomous software agent system 100 to retrieve information based on specific triggers that might be relevant to the session. As also mentioned, this knowledge (depending on the trigger) is retrievable across all sessions.

As mentioned above, the autonomous software agent system 100 uses the autonomous software agent system 100 which deploys autonomous software agents that have access to their own machines. In particular, for each new spun up session, the autonomous software agent system 100 spins up a new development box (e.g., sandbox) which includes a fully featured IDE (shell, an editor, a bowser, etc.). Moreover, the autonomous software agent system 100 allows a development box to be customized in a user’s workspace (e.g., Devin’s Workspace), where the user can save a specific machine snapshot that the autonomous software agent system 100 will use each time it spins up a new development box.

Furthermore, the autonomous software agent system generates development boxes that are isolated virtual machines. In particular, the development boxes run on top of a custom hypervisor implemented to support the virtual machine technology. Moreover, the state of a run (e.g., deploying an autonomous software agent) can be rolled-back to an earlier point in time. In running back to an earlier point in time, the autonomous software agent system 100 rolls back both the state of “Devin’s brain” (e.g., the knowledge and the progress on a certain task), as well as the state of Devin’s machine (e.g., the machine contents).

Moreover, in some embodiments, the autonomous software agent system 100 offers a virtual private cloud (VPC) deployment solution that allows development boxes to run within a customer’s (a set of users) cloud tenant with the “Devin brain” (e.g., a component of the autonomous software agent) interacting with the development boxes over a secure tunnel. All data related to sessions are stored at rest in the customer cloud tenant.

Furthermore, each of these development boxes (or sessions) can speak to the customer-hosted services (connected via API integrations). Accordingly, the autonomous software agent system 100 can leverage the AI layer 740, the data layer 730, the backend services 716, and the frontend layer 708 to cause the graphical user interface on the user computing device to display the actions taken by the autonomous software agent (e.g., the actions via the software composition tools of the autonomous software agent).

Further, as already mentioned, the autonomous software agent system 100 includes machine learning models. In particular, the autonomous software agent system 100 utilizes pre-trained machine learning models to translate descriptions (e.g., from a response to a prompt) into artificial intelligence outputs (e.g., artificial intelligence plans, computer code, terminal commands, navigation actions, etc.). Moreover, the machine learning models utilized by the autonomous software agent system 100 have been trained on vast amounts of computer code data, which allows them to identify patterns and generate functional code. In some embodiments, the autonomous software agent system 100 utilizes the machine learning models to process the extracted information (e.g., key functionalities and requirements). In particular, the autonomous software agent system 100 utilizes the machine learning models to search for patterns and identify similar code structures from their training data.

Additionally, the autonomous software agent system 100 includes the code generation model 746. In particular, based on processed information from the natural language processing and the machine learning models, the autonomous software agent system 100 translates the descriptions into actual computer code. In other words, the output of the natural language processing and the machine learning model is pulled into the code generation engine to create viable computer code. In some embodiments, based on identified patterns, the autonomous software agent system 100 utilizes the code generation engine to create functional code responsive to deploying an autonomous software agent after generating a response to a prompt.

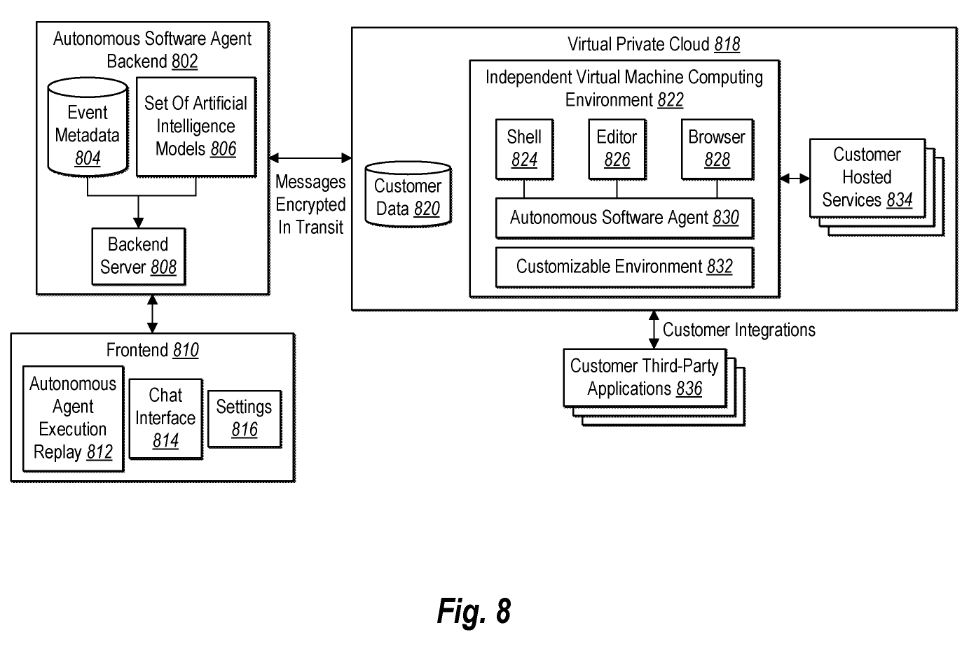

FIG. 8 illustrates additional details of the architecture of the autonomous software agent system 100 in accordance with one or more embodiments. For example, FIG. 8 shows that for each session of deploying an autonomous software agent, the autonomous software agent system 100 spins up/deploys an autonomous software agent backend 802 that includes a “backend container” paired with “a development box” virtual machine. In other words, the autonomous software agent system 100 initializes a development box (e.g., an independent virtual machine computing environment) with an autonomous software agent backend that includes a set of artificial intelligence models 806. As mentioned above, the set of artificial intelligence models 806 contains one or more machine learning/artificial intelligence models shown above used to process, analyze, and generate data.

As shown in FIG. 8, the autonomous software agent backend 802 includes event metadata 804 (e.g., context surrounding a prompt/request submitted to a web application interface, a response to the prompt, or other external sources that contain contextual data), the set of artificial intelligence models 806 (e.g., one or more machine learning models shown and discussed in FIG. 7), and a backend server 808 (e.g., a server that handles logic, database interactions, authentication, and other services for deploying an autonomous software agent).

Further, FIG. 8 shows the autonomous software agent backend 802 interacting with a frontend 810 which includes autonomous agent execution replay 812 (e.g., replay for a timelapse of a development session, a session replay that is a recording of previous user interactions with the autonomous software agent system 100), chat UI 814 (e.g., the graphical user interface provided to a user to submit prompts), and settings 816 (e.g., custom settings established by the autonomous software agent system 100 or by a user).

Moreover, the autonomous software agent backend 802 communicates with a virtual private cloud 818 (e.g., a customer virtual private cloud, which is a dedicated and isolated virtual network within a public cloud service) via encrypted messages. In particular, FIG. 8 shows an independent virtual machine computing environment 822 hosted on the virtual private cloud 818 and the virtual private cloud 818 further includes customer data 820.

Additionally, the independent virtual machine computing environment 822 further includes a shell 824, an editor 826 (e.g., integrated development environment), a browser 828, an autonomous software agent 830, a customizable environment 832 (e.g., playbooks, knowledge, etc. that customize an independent virtual machine computing environment) and customer hosted services 834 (e.g., services or applications hosted and managed by a tenant organization). Additionally, FIG. 8 shows that the virtual private cloud 818 can integrate various applications via access tokens/API keys. In particular, the autonomous software agent system can use the independent virtual machine computing environment 822 (e.g., the autonomous software agent) to write various code and make integrations with applications integrated with the virtual private cloud 818 (e.g., customer third-party applications 836).

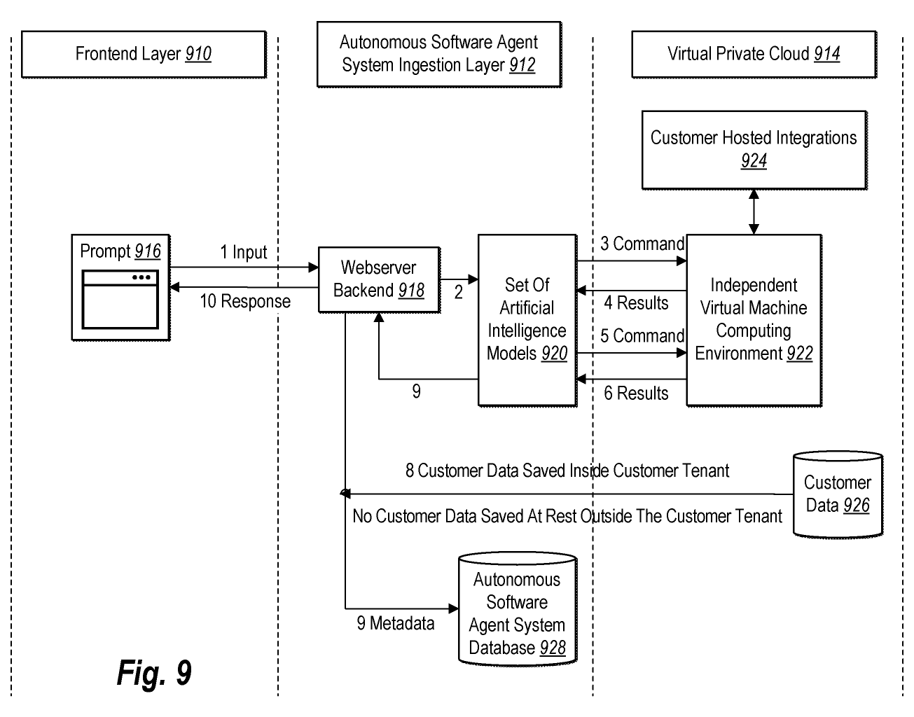

Further, FIG. 9 shows that the autonomous software agent system 100 receives a prompt 916 via a frontend layer 910. As shown, the autonomous software agent system 100 passes the prompt 916 to an autonomous software agent system ingestion layer 912. In response to the prompt 916, the autonomous software agent system 100 responds to the prompt 916 with a webserver backend 918 and further passes the information to a set of artificial intelligence models 920 (e.g., one or more artificial intelligence models shown above in FIG. 7).

As further shown in FIG. 9, the autonomous software agent system 100 passes commands/results back and forth between a virtual private cloud 914 (e.g., an independent virtual machine computing environment 922) and the set of artificial intelligence models 920. In other words, FIG. 9 illustrates the interaction between the frontend layer 910 of the autonomous software agent system 100, the backend of the autonomous software agent system 100, and an autonomous software agent deployed for performing tasks at the virtual private cloud 914. Furthermore, the independent virtual machine computing environment 922 also accesses customer hosted integrations 924 at the virtual private cloud 914.

Additionally, FIG. 9 shows customer data 926 at the virtual private cloud 914 which the autonomous software agent system 100 passes all customer data saved inside customer tenant to the tenant (e.g., and no customer data is saved at rest outside the customer tenant). Moreover, FIG. 9 shows the autonomous software agent system 100 using the webserver backend 918 to pass metadata to an autonomous software agent system database 928.

In one or more embodiments, the autonomous software agent system 100 receives an autonomous software agent prompt and deploys an autonomous software agent, which includes one or more machine learning components (e.g., large language models). In one or more embodiments, the autonomous software agent system 100 utilizes a text encoder to generate a set of text tokens for the autonomous software agent prompt.

Moreover, based on the text tokens, the autonomous software agent system 100 generates an artificial intelligence plan (e.g., breaks down the software task), and further reasons how to complete one or more tasks. In particular, the autonomous software agent system uses the independent virtual machine computing environment 922 to communicate with the set of artificial intelligence models 920 (e.g., the artificial intelligence components shown in FIG. 7) to determine which shell commands to make, computer code to write (e.g., in the editor), and webpages to browse.

In one or more embodiments, the autonomous software agent system 100 further utilizes a text encoder to process a prompt/request to deploy an autonomous software agent. In particular, the text encoder includes a component of a neural network to transform textual data (e.g., the text prompt) into a numerical representation. For instance, the autonomous software agent system 100 utilizes the text encoder to transform the prompt into a text encoding (e.g., text tokens). Further, the autonomous software agent system 100 utilizes the text encoder in a variety of ways.

For instance, the autonomous software agent system 100 utilizes the text encoder to i) determine the frequency of individual words in the text prompt (e.g., each word becomes a feature vector), ii) determines a weight for each word within the text prompt to generate a text vector that captures the importance of words within a text prompt, iii) generates low-dimensional text vectors in a continuous vector space that represents words within the text prompt, and/or iv) generates contextualized text vectors by determining semantic relationships between words within the text prompt.

Furthermore, although not shown in FIGS. 7-9, in one or more embodiments, the autonomous software agent system trains the set of artificial intelligence models 920 (e.g., artificial intelligence components such as the code generation engine, the natural language processing, and the machine learning models). For example, the autonomous software agent system 100 leverages a set of large language models and fine-tunes each large language model for different tasks. In particular, the autonomous software agent system 100 has a large language model for terminal requests, a large language model for generating computer code, a large language model for generating a plan, and a large language model for performing website browsing actions and determining a relevance of certain portions of a website domain page.

Moreover, the autonomous software agent system 100 trains the set of artificial intelligence models 920 by sending an input task to one or more of the large language models, generates a prediction for the input task, and compares the prediction with a ground truth reference. Based on the comparison, the autonomous software agent system 100 fine-tunes or modifies parameters of one or more large language models (e.g., that are part of the set of artificial intelligence models 920). Thus, at inference time, the autonomous software agent system 100 performs advanced reasoning tasks fine-tuned for specific use cases.

In addition, as alluded to above, the autonomous software agent system 100 trains machine learning models to translate descriptions into code. In some embodiments, the autonomous software agent system 100 trains multiple machine learning models for discrete tasks. In particular, the autonomous software agent system 100 trains a machine learning model to generate specific types of functional code. For example, the autonomous software agent system 100 utilizes a machine learning model to generate computer code from a description and compares the description to a ground truth reference and fine-tunes/modifies parameters of the machine learning model.

Moreover, the autonomous software agent system 100 further continuously learns from feedback and developer interactions. In particular, the autonomous software agent system 100 deploys autonomous software agents that perform a variety of tasks, and in response to prompts and/or feedback (e.g., user intervention), the autonomous software agent system 100 learns from the interactions to improve its capabilities. In other words, the autonomous software agent system 100 fine-tunes the artificial intelligence components in response to updates/feedback received from users.

FIGS. 8-9 describe various architectural details of the autonomous software agent system 100. In particular, the architectural components of the autonomous software agent system 100 enables an autonomous software agent to perform a variety of tasks. To illustrate, the autonomous software agent system 100 performs repetitive coding tasks such as generating boilerplate code, data validation routines, and unit tests.

Moreover, the autonomous software agent system 100 performs code revies (e.g., one or more software developers examine code written by others to identify potential issues and provide feedback) and debugging such as analyzing code to identify potential bugs and suggesting fixes/improvements. Furthermore, the autonomous software agent system 100 performs deployment automation to automate a deployment process of software (e.g., streamlining the transition from development to production).

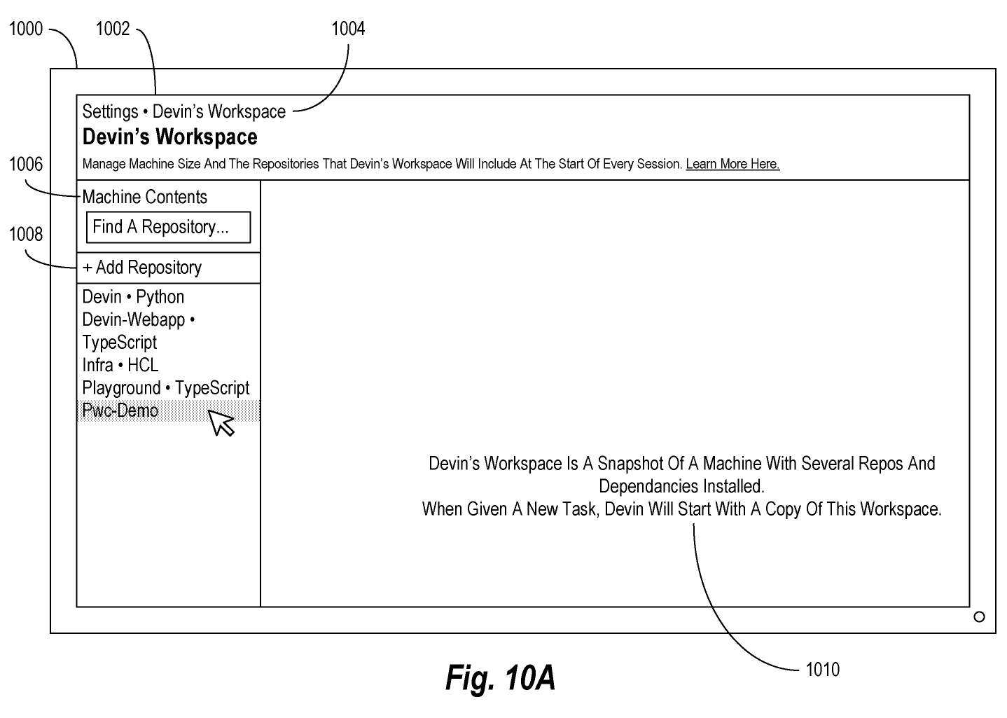

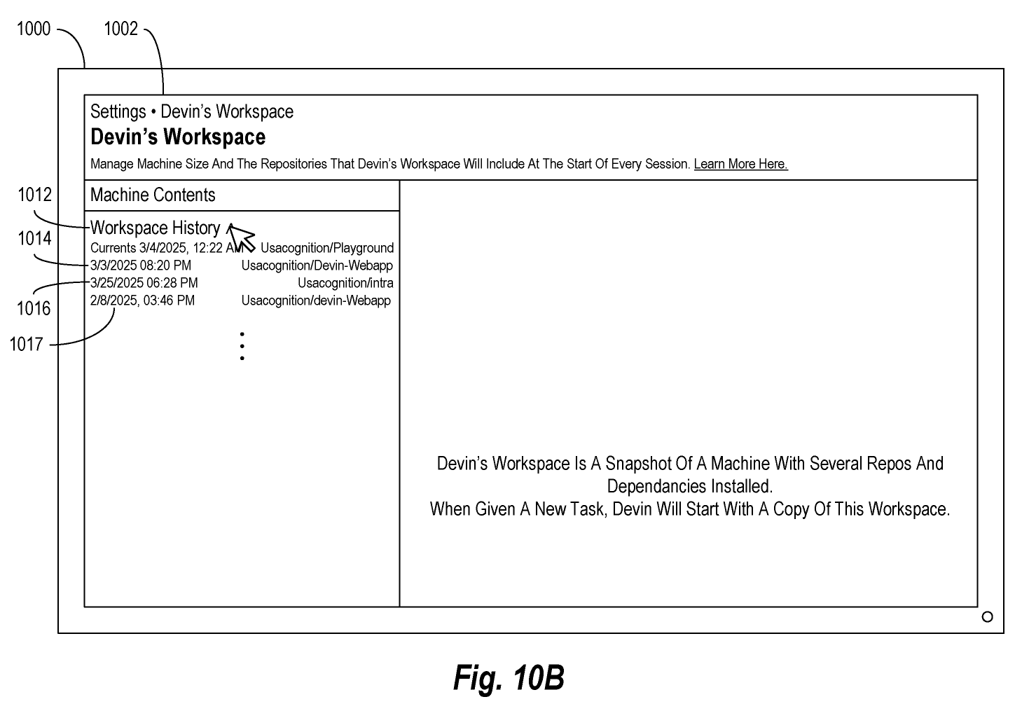

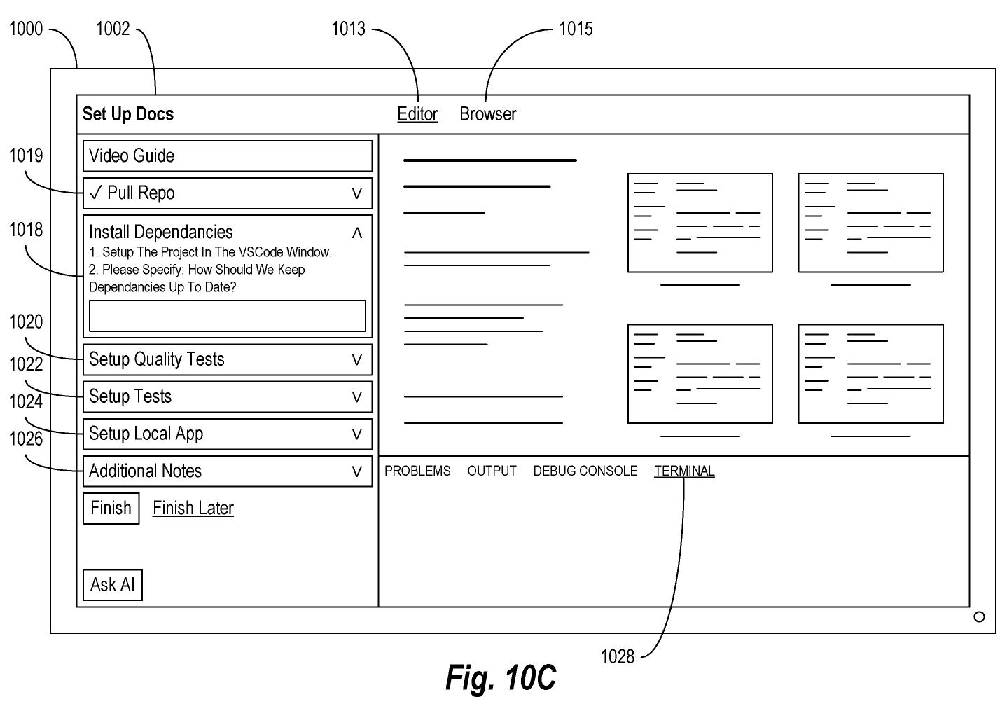

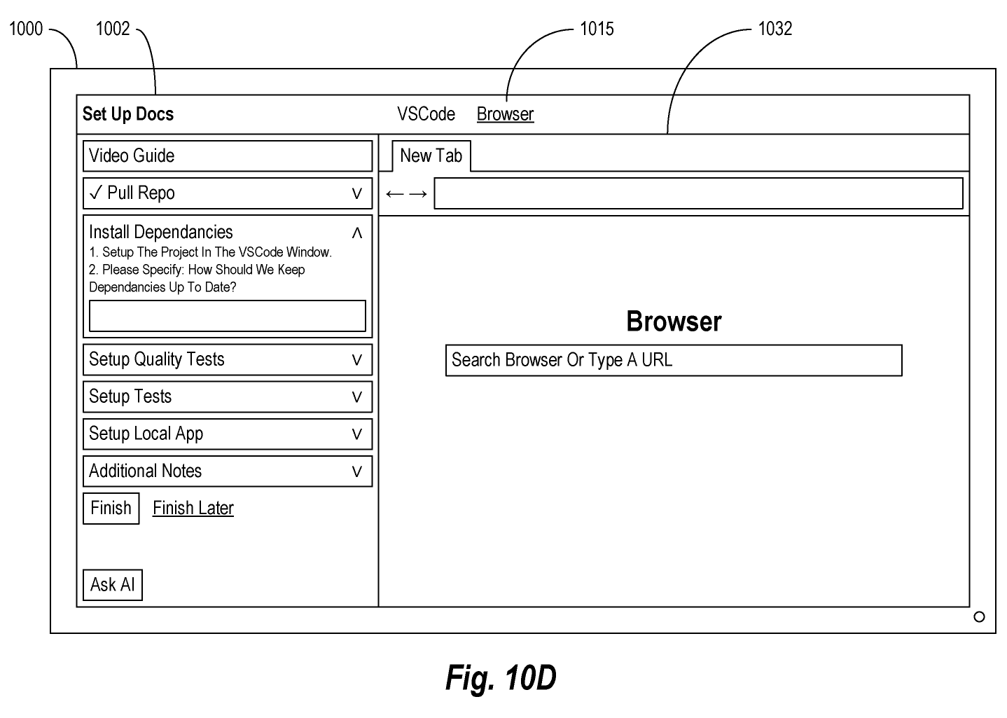

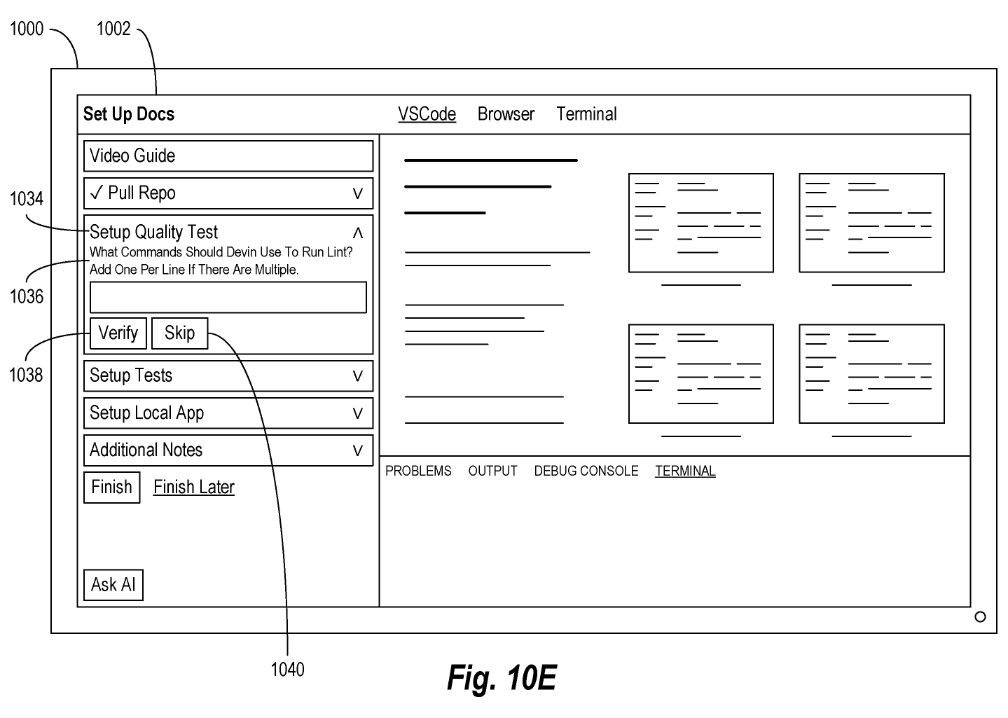

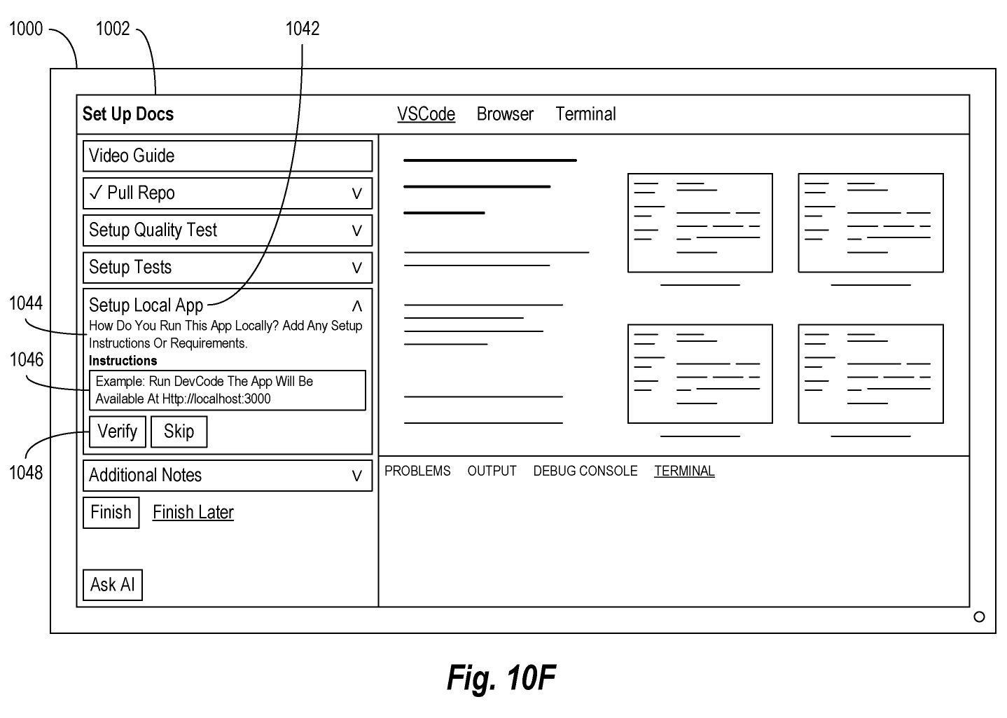

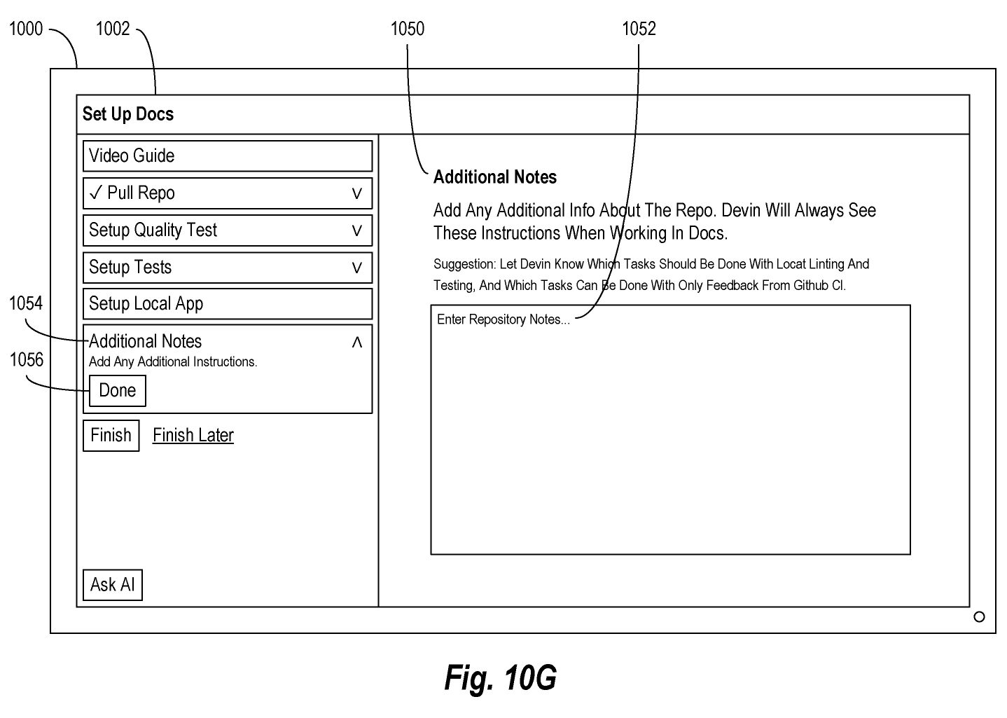

FIGS. 10A-10B illustrates an example graphical user interface of the autonomous software agent system providing for display options to configure machine contents and restore states (snapshots) of the autonomous software agent in accordance with one or more embodiments. For example, FIG. 10A shows a workspace 1004 and a configuration option 1006 of the machine contents. In particular, FIG. 10A shows a graphical user interface 1002 of a user computing device 1000 and shows an additional configuration option 1008 to add a code repository. Moreover, FIG. 10A shows guidance information 1010 that reads “Devin’s workspace is a snapshot of a machine with several repos and dependencies installed. When given a new task, Devin will start with a copy of this workspace.”

As shown, the configuration option 1006 allows the user computing device 1000 to select machine contents. In one or more embodiments, machine contents refer to data configuration and software that are part of a virtual machine. In particular, the machine contents refer to a make-up of an environment in which the virtual machine operates, such as an operating system and resources that the virtual machine uses to function. For example, the machine contents include an operating system, applications and services, system files, configuration files, a virtual disk, memory, CPU resources, network configuration, logs, snapshot and checkpoints, and access permissions.

Further, FIG. 10B further shows a workspace history 1012 to restore or start an autonomous software agent at a certain state (e.g., snapshot). In particular, FIG. 10B shows a first snapshot state 1014, a second snapshot state 1016, and a third snapshot state 1017. In one or more embodiments, a state (snapshot) refers to a point-in-time copy or capture of a state of a machine. In particular, the state includes a current configuration, disk contents, memory, and settings of a virtual machine (e.g., a previously deployed autonomous software agent). In other words, the autonomous software agent system 100 deploys a new autonomous software agent to have the machine contents of a previous autonomous software agent.

As mentioned above, the autonomous software agent system 100 deploys an autonomous software agent that has access to a shell, editor, planner and browser. Furthermore, as shown in FIG. 10B, the autonomous software agent system 100 has the ability to capture a snapshot of previous workspaces as a new task starting points.

In some embodiments, the autonomous software agent system 100 leverages the artificial intelligence components (e.g., the set of artificial intelligence models discussed above) to interact with a development box (e.g., to run commands and browse the web). In particular, the autonomous software agent system 100 uses the workspace configurations shown in FIGS. 10A-10B and deploys an autonomous software agent to create a unique code generator that operates independently (e.g., unlike existing tools that are only are built to use one at a time). In other words, the autonomous software agent system 100 deploys an autonomous software agent that includes the artificial intelligence components and the development box (e.g., shell, browser, editor, planner, etc.).

As mentioned above, the development box is housed separately from the set of artificial intelligence models. In particular, due to the separate housing, the autonomous software agent system 100 runs the browser inside the development box instead of the set of artificial intelligence models. In some embodiments, the autonomous software agent system 100 utilizes website browser development tool protocols to remotely connect to the set of artificial intelligence models and control a browser.

In one or more embodiments, the autonomous software agent system 100 deploys the autonomous software agent that is browsing a website with a lot of information. As such, the autonomous software agent system 100 optimizes the website being browsed such that a large language model (e.g., LLM part of the set of artificial intelligence models) can process the website within its context window. In particular, the autonomous software agent system 100 distills the website structure and gives the HTML to a set of artificial intelligence models (“Devin’s brain” also known as an autonomous software agent backend) to process the relevant portions (e.g., the portions that satisfy a threshold level of relevance). Due to optimizing the amount of information processed by the autonomous software agent system 100, the autonomous software agent system 100 can process very large websites without performance degradation.

In one or more embodiments, the autonomous software agent system 100 further allows for VPN configuration (virtual private network). In some embodiments, the autonomous software agent system 100 deploys an autonomous software agent that operates in its own virtual machine workspace and needs to access resources within a user’s internal network. In particular, the autonomous software agent may need to access an internal package registry, staging services, and self-hosted services. Similar to human developers, the autonomous software agent system 100 can use the autonomous software agent to use a client VPN to connect to an internal network. In some embodiments, the autonomous software agent system 100 provides an option for a user to upload a configuration file of a private VPN to the workspace (e.g., via a drag and drop).

As mentioned above, the autonomous software agent system 100 uses the workspace configurations and deploys an autonomous software agent to create a unique code generator that operates independently. FIGS. 10C-10G provide additional context for the autonomous software agent system 100 providing configuration options to deploy the autonomous software agent in a working development environment in accordance with one or more embodiments.

In contrast to existing systems which run “digital assistants” and “code generators” on a user’s computing device, the autonomous software agent system 100 provides configuration options for deploying an autonomous software agent to run independently, isolated, and siloed from a user’s computing device. FIG. 10C shows the autonomous software agent system 100 providing an option to connect a repository in accordance with one or more embodiments.

As shown in FIG. 10C, the autonomous software agent system 100 provides for display an editor tab 1013 (VSCode) and a browser tab 1015. FIG. 10C shows a selection of the editor tab 1013 and code corresponding to the editor tab 1013 and a relevant project file. Additionally, FIG. 10C shows a terminal tab 1028 which shows relevant terminal commands submitted by an autonomous software agent.

Additionally, FIG. 10C shows a connection option 1019 to connect to a specific code repository. In particular, the connection option 1019 allows the autonomous software agent system 100 to create pull requests, automatically respond to pull request comments, and other actions related to a connected code repository. In other words, the autonomous software agent system 100 allows a user to configure one or more repositories for the autonomous software agent. Indeed, the autonomous software agent system 100 allows a user to clone any repository from their codebase into a virtual machine of the autonomous software agent system 100.

Additionally, FIG. 10C shows an install dependencies option 1018, which allows the autonomous software agent system 100 to setup computer code dependency libraries. In particular, a selection of the install dependencies option 1018 allows a user computing device to setup projects and specify dependencies to keep the autonomous software agent appraised/up to date with the necessary skills/context to execute a software task. To illustrate the install dependencies option 1018 includes a process of downloading and configuring externa libraries, frameworks, and/or tools that a software program relies on to run or to build correctly.

Furthermore, FIG. 10C shows a setup quality tests option 1020, which refers to a process of configuring automated checks that measure code quality, rather than correctness. In particular, a selection of the setup quality tests option 1020 refers to a process of tests that analyze linters (e.g., formatting and style rules), static analysis tools, code coverage thresholds, and security or dependency vulnerability scans.

Moreover, FIG. 10C shows a setup tests option 1022, which allows the autonomous software agent system 100 to configure and prepare automated tests that verify that software (e.g., computer code) behaves correctly. In particular, a selection of the setup tests option 1022 allows a user computing device to further improve the technical accuracy and efficiency of an autonomous software agent executing a software task by setting up test frameworks, test data, mocks, and test environments.

Additionally, FIG. 10C shows a setup local app option 1024, which refers to steps required to run an application on a virtual machine (e.g., independent virtual machine computing environment) of an autonomous software agent. In particular, a selection of the setup local app option 1024 includes configuring environment variables, local databases, services, and startup commands. To illustrate, setting local app options can include running local servers, connecting to local or sandbox services, and configuring environment files.

Moreover, FIG. 10C shows an additional notes option 1026, which refers to an extract section to provide additional guidance, context, caveats, or instructions that do not fit in the other configuration option categories. In particular, the additional notes option 1026 can include assumptions, limitations, troubleshooting tips, or environment-specific tips.

As shown in FIG. 10D, the graphical user interface 1002 of the user computing device 1000 shows a selection of the browser tab 1015. In particular, FIG. 10D shows a browser tool being utilized by an autonomous software agent executing a software task via a browser 1032. Further, FIG. 10E shows a selection 1034 of the setup quality tests option. In response, FIG. 10E shows the graphical user interface 1002 displaying options to setup quality tests. In particular, FIG. 10E shows instructions 1036 that indicate “what command should Devin use to run Lint? Add one per line if there are multiple.” Moreover, FIG. 10E shows an input element to input the quality tests, a verify option 1038 and a skip option 1040.

Further, FIG. 10F shows a selection 1042 of setting up a local application. In particular, FIG. 10F shows instructions 1044 that read “how do you run this app locally? Add any setup instructions or requirements.” Additionally, FIG. 10F shows an input element 1046 that provides an example of “run DevCode: the app will be available at http”//localhost:3000.” Further, FIG. 10F shows a verify option 1048. Moreover, FIG. 10G shows a selection 1054 of additional notes. Further, FIG. 10G shows an option to submit additional notes and an option 1056 to confirm the submission of additional notes. In particular, FIG. 10G shows an expanded additional notes interface 1050 and a text element input 1052 to enter repository notes.

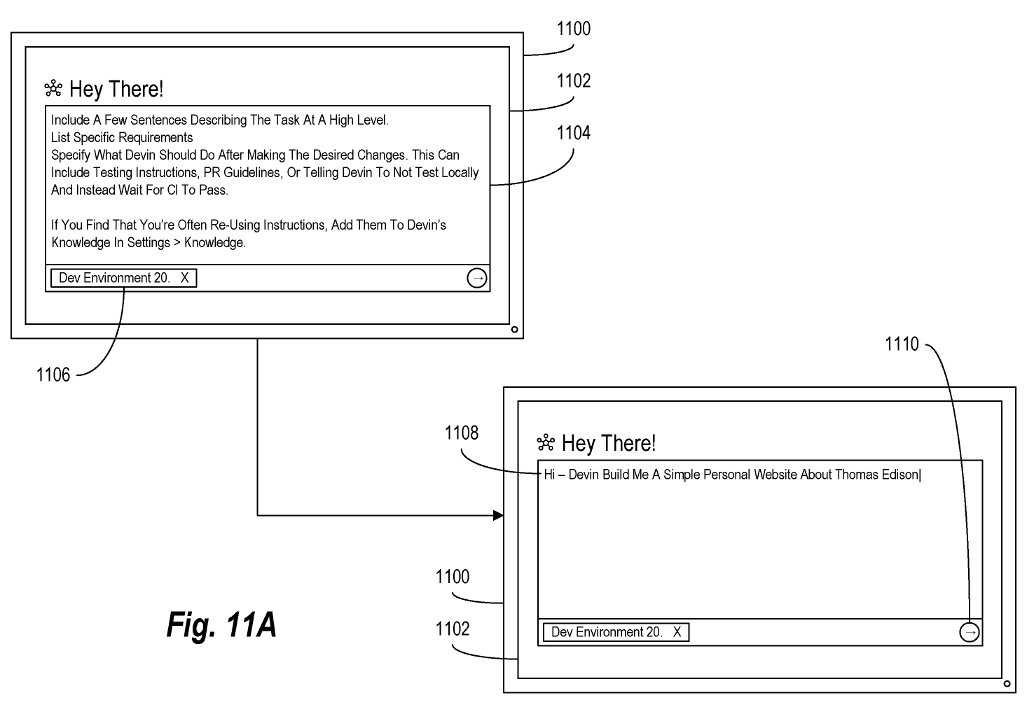

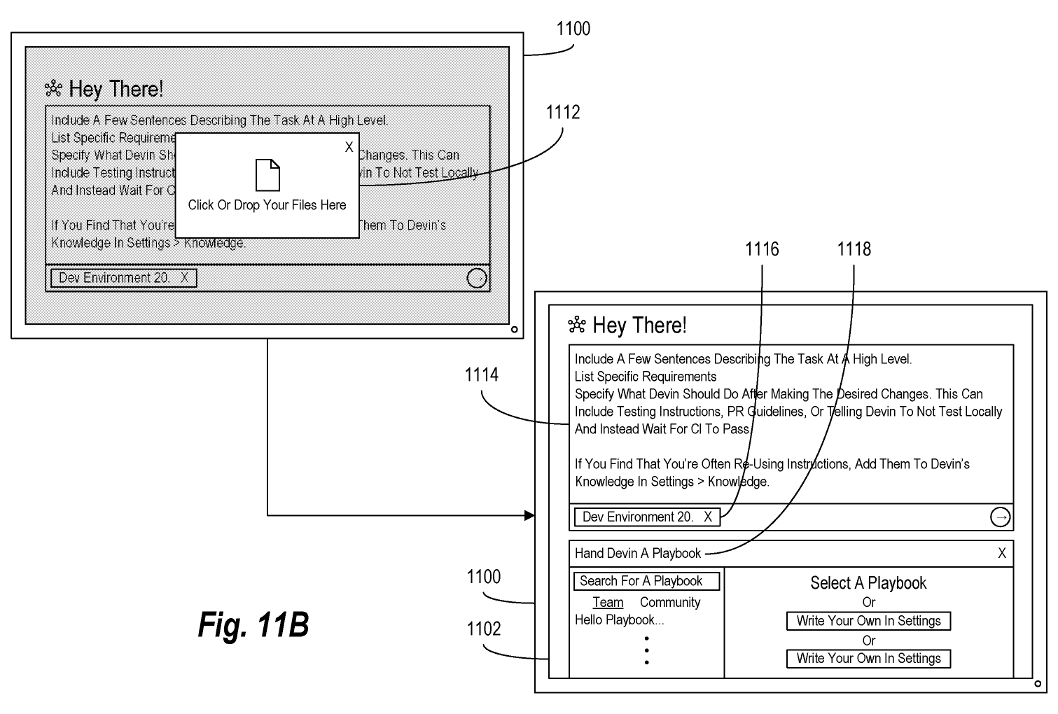

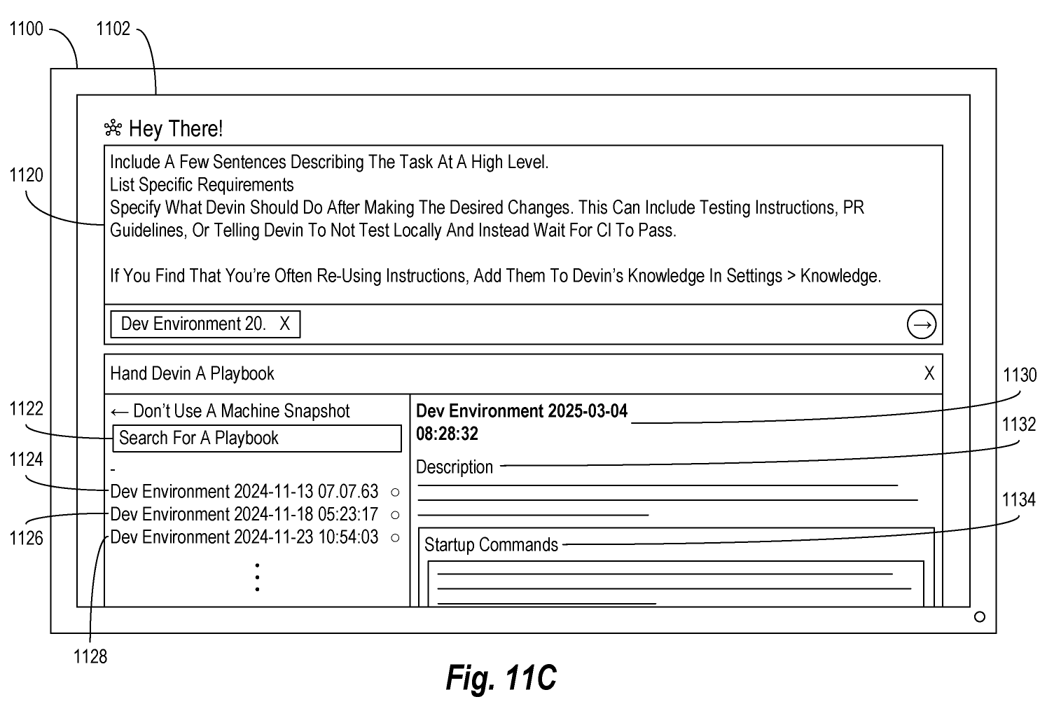

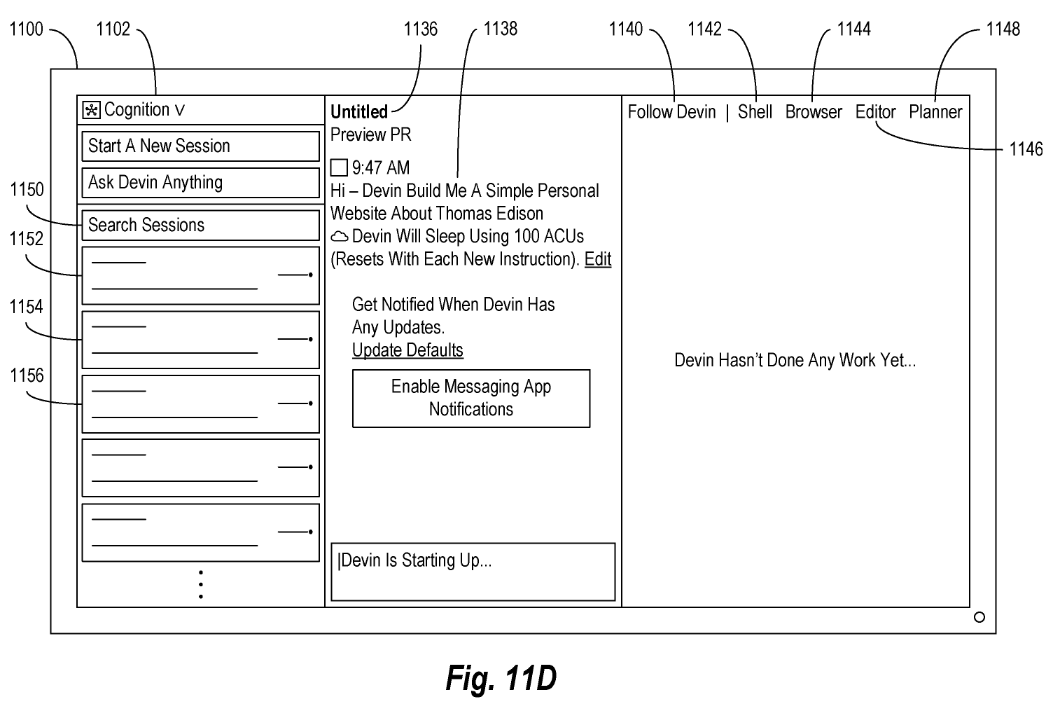

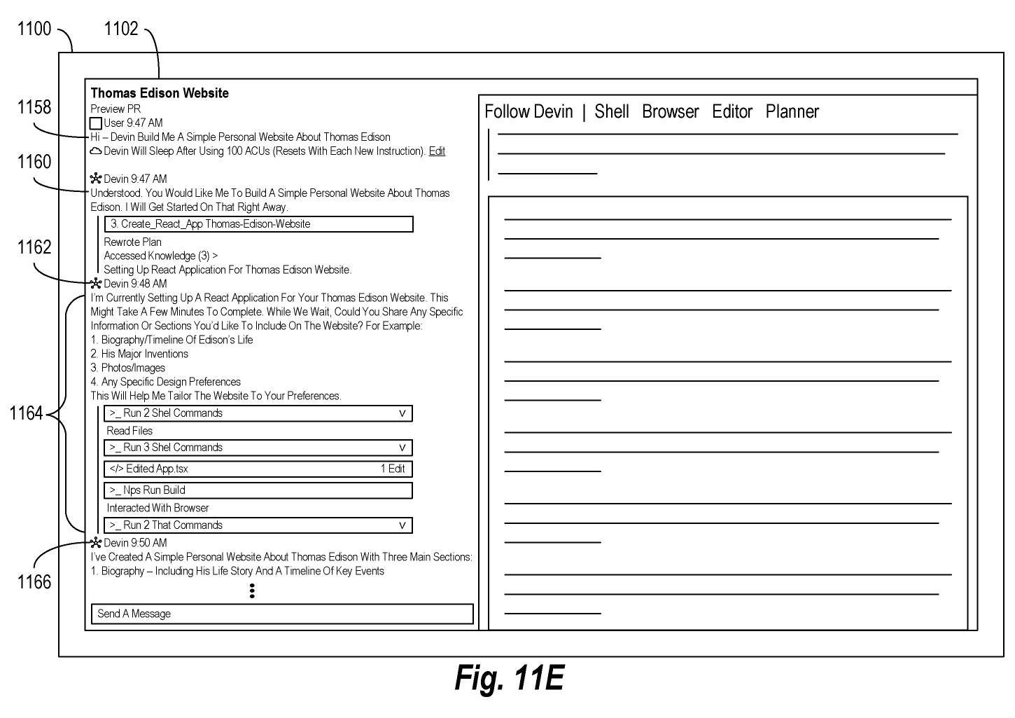

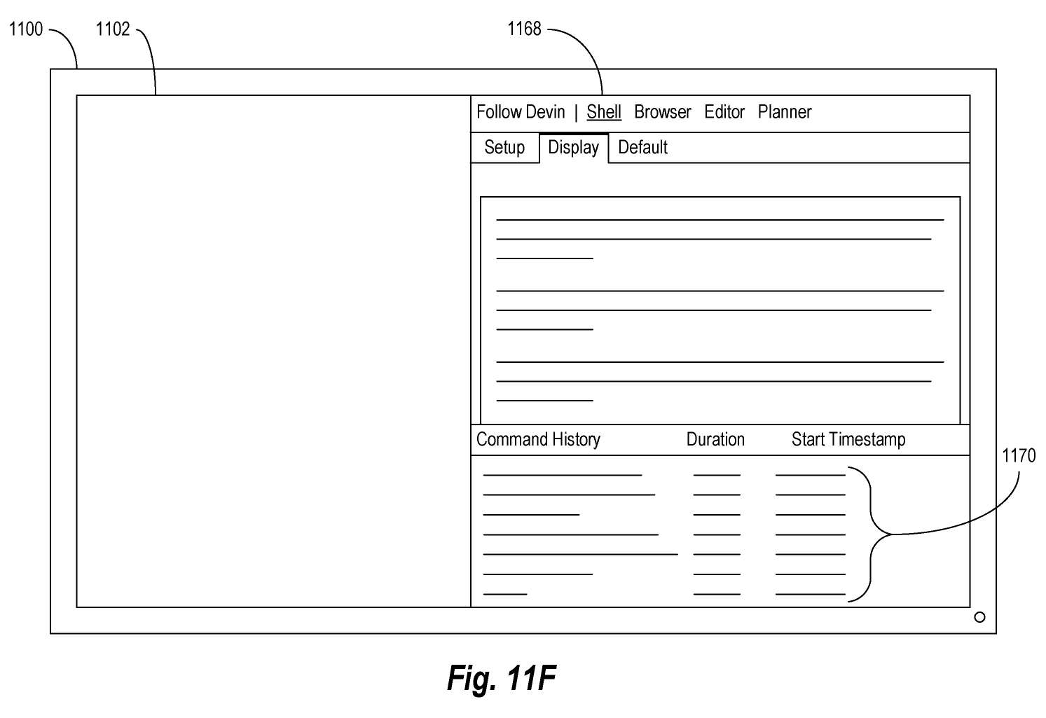

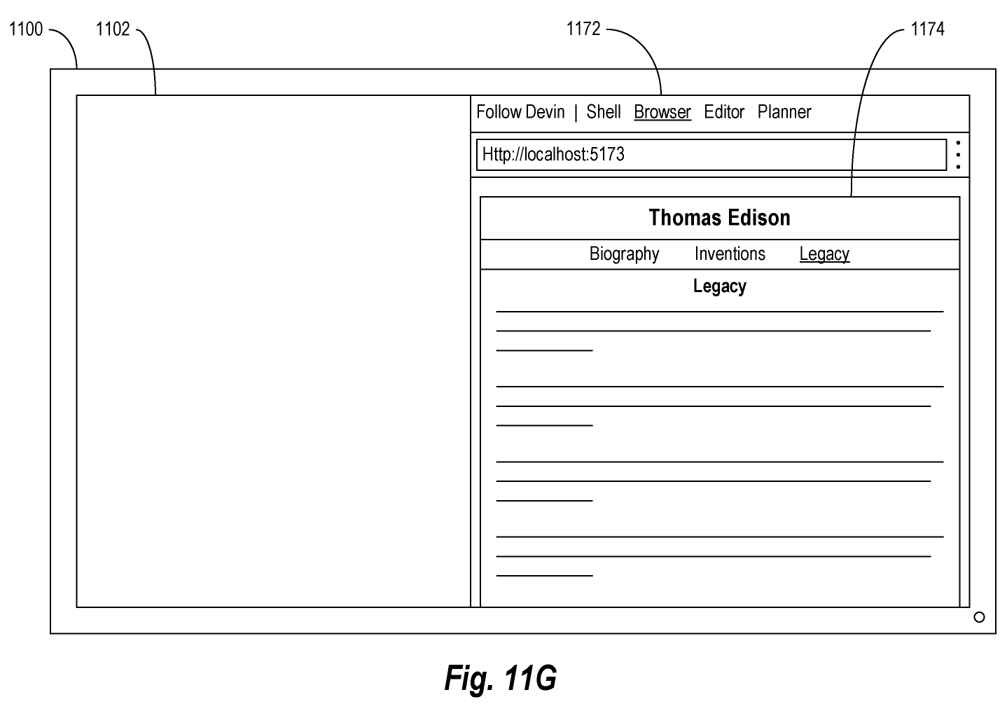

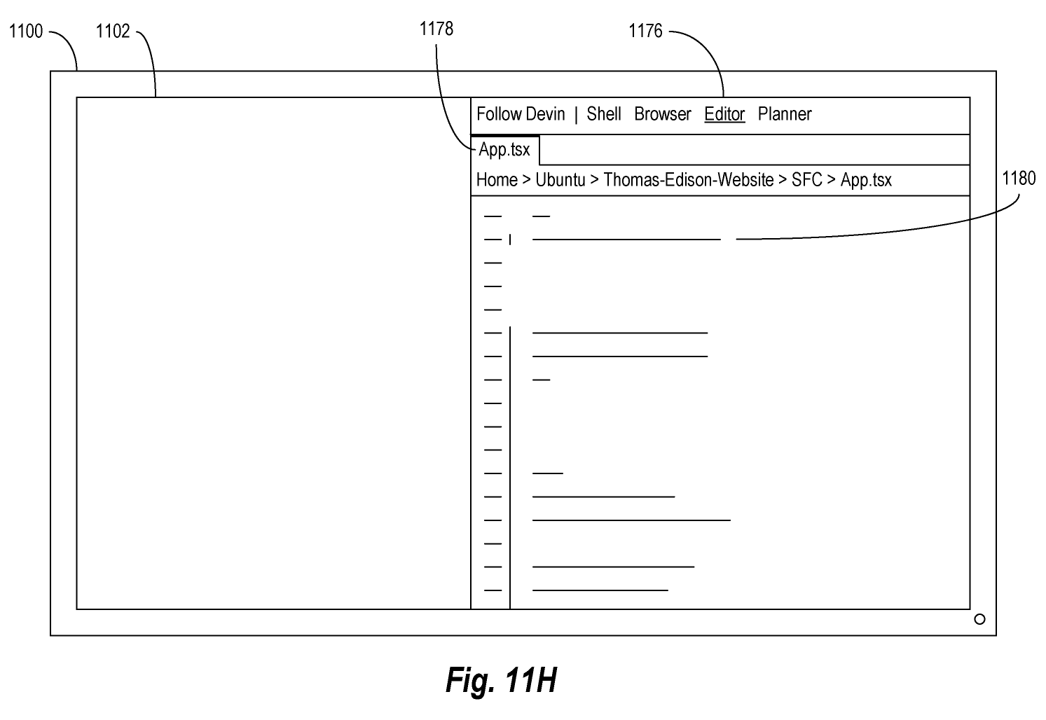

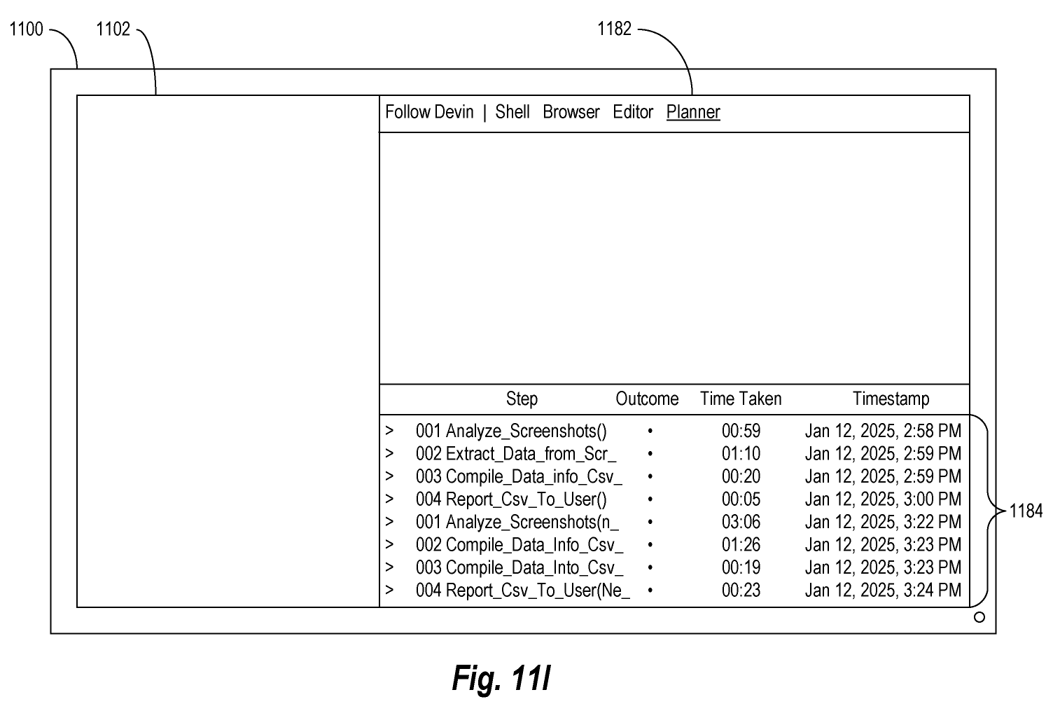

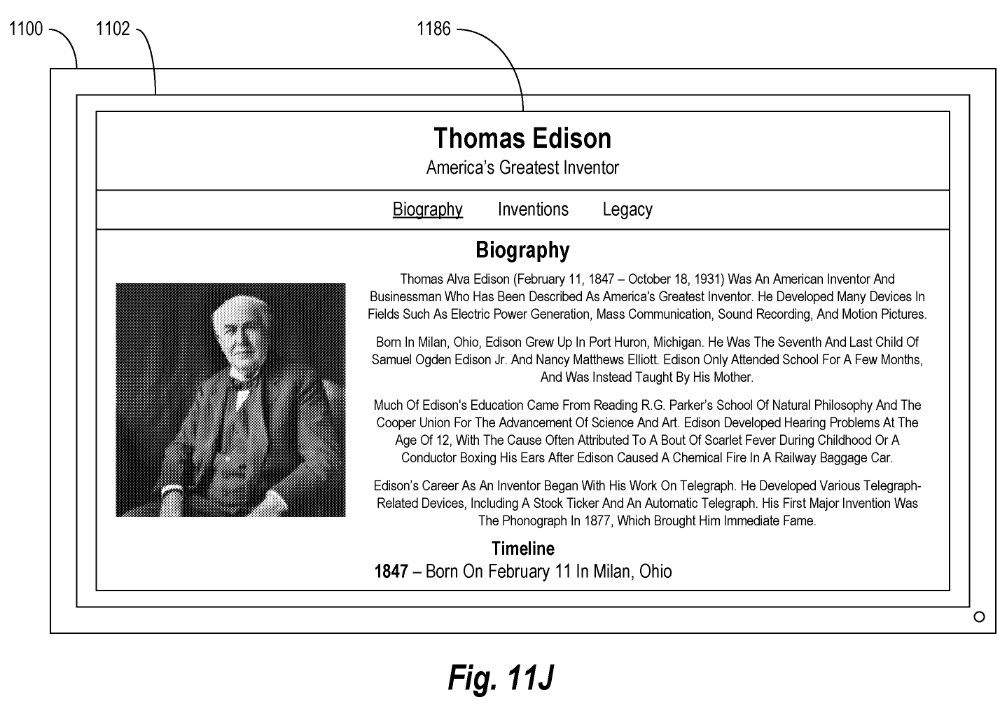

FIGS. 11A-11J show an example flow of the autonomous software agent system 100 deploying an autonomous software agent to generate a website domain page. For example, FIG. 11A shows a graphical user interface 1102 of a user computing device 1100 for a user to submit prompts to the autonomous software agent system 100 via a prompt input element 1104. In particular, FIG. 11A shows the autonomous software agent system 100 receiving a prompt 1108 to build a personal website about Thomas Edison and a submission option 1110 to submit the prompt 1108.

Moreover, in some embodiments, the autonomous software agent system 100 via the prompting interface can prompt a user computing device. In particular, the autonomous software agent system 100 can query a user as to whether an autonomous software agent should ingest a certain code library (e.g., ask permission to access a code library). In some embodiments, the autonomous software agent system 100 can query a user with clarifying questions as to how to proceed with certain tasks. Moreover, in some embodiments, the autonomous software agent system 100 continues to execute a portion of task after a threshold period of time has passed without the user responding to a prompt from the autonomous software agent system 100. FIG. 11A shows a machine state selection 1106 that specifies a specific environment with which to configure a computing environment of an autonomous software agent.

Further, FIG. 11B shows the autonomous software agent system 100 further providing an interface to configure an autonomous software agent. In particular, FIG. 11B shows an option 1112 to drag and drop files, to select playbooks 1118, and to select machine contents 1116 of an autonomous software agent. Moreover, FIG. 11B shows a chat interface 1114 between the autonomous software agent system 100 and the user computing device 1100.

FIG. 11C further shows the autonomous software agent system 100 causing the graphical user interface 1102 to display instructions 1120. In particular, the instructions 1120 indicate that a user computing device can include a few sentences describing a task and specifying how the autonomous software agent system 100 can make changes. Moreover, FIG. 11C shows the autonomous software agent system 100 providing a first snapshot 1124, a second snapshot 1126, and a third snapshot 1128 for a user computing device to select from to activate the autonomous software agent at a specific snapshot. Moreover, FIG. 11C shows an option 1122 to search for a playbook.

Additionally, FIG. 11C shows development environment 1130 with a corresponding description 1132, and startup commands 1134. In particular, the autonomous software agent system 100 can cause the graphical user interface 1102 to display the aforementioned details to give an opportunity for a user computing device to make one or more changes to a configuration of an autonomous software agent.

Furthermore, FIG. 11D shows a workspace that includes a first past session 1152, a second past session 1154, and a third past session 1156. Moreover, FIG. 11D shows an option 1150 to search through a plurality of past sessions (e.g., prior autonomous software agents). Additionally, FIG. 11D shows a title 1136 and development steps 1138 based on the autonomous software agent system 100 initiating a development session.

Moreover, FIG. 11D shows an option 1140 to follow an autonomous software agent as it executes the software task of building a website domain page. Furthermore, FIG. 11D shows a shell interface 1142, a browser interface 1144, an editor interface 1146, and a planner interface 1148. In particular, as alluded to above, in response to a selection of one of the aforementioned interfaces, the autonomous software agent system 100 can display actions taken by the autonomous software agent as it builds the website domain page. Moreover, in response to a selection of the option 1140 to follow the autonomous software agent, the autonomous software agent system 100 causes the graphical user interface 1102 to switch back and forth between different software composition tools as the autonomous software agent accesses those different tools.

FIG. 11E shows the autonomous software agent system 100 displaying an artificial intelligence plan to build the website domain page. For example, FIG. 11E shows a prompt 1158 (e.g., Hi -Devin build me a simple personal website about Thomas Edison). Moreover, FIG. 11E shows a response 1160 (e.g., understood. You would like me to build a simple personal website about Thomas Edison…).

Further, FIG. 11E shows an additional response 1162 with a request for additional guidance 1164. In particular, the request for additional guidance 1164 reads “I’m currently setting up a react application for your Thomas Edison website. This might take a few minutes to complete. While we wait, could you share any specific information or sections you’d like to include on the website? For example: 1. biography/timeline of Edison’s life, 2. His major inventions, 3. Photos/images, 4. Any specific design preferences…” Additionally, FIG. 11E shows an additional response 1166 from the autonomous software agent system 100 indicating a current stage in the development session.

Moreover, FIG. 11F shows a shell interface 1168, which was discussed above. In particular, the shell interface shows deployed code, and a command history of command submitted to a computer terminal. In particular, FIG. 11F shows a plurality of terminal commands 1170 submitted by an autonomous software agent as it executes a software task.

Additionally, FIG. 11G shows a website of a browser tool selection 1172. For example, FIG. 11G shows what the autonomous software agent currently “sees” via a web browser. In particular, FIG. 11G shows a browser interface 1174 of the autonomous software agent displaying the Thomas Edison website domain page.

Moreover, FIG. 11H shows a selection of an editor tool 1176, a corresponding project file 1178, and lines of written computer code 1180. In particular, a selection of the editor tool 1176 causes the graphical user interface 1102 to display code written by the autonomous software agent. In some embodiments, the autonomous software agent system 100 allows a user to supervise, review and edit the code in the editor. Additionally, FIG. 11I shows a selection of a planner tool 1182. Moreover, FIG. 11I shows an artificial intelligence plan 1184 to execute a software task of building the Thomas Edison website. In other words, FIG. 11I shows how an autonomous software agent breaks down a task. Additionally, FIG. 11J shows the Thomas Edison website created by the autonomous software agent. In particular, FIG. 11J shows a website domain interface 1186 displaying Thomas Edison with different sections (e.g., biography, inventions, legacy, etc.).

Although not shown in FIGS. 11A-11J, in one or more embodiments, the autonomous software agent system 100 further causes an autonomous software agent to go to sleep. In particular, the autonomous software agent system 100 identifies when a user computing device (e.g., who submitted a request) has not had a threshold amount of activity for a threshold period of time and causes the autonomous software agent to go to sleep (e.g., pause activity). Moreover, in some embodiments, the autonomous software agent system 100 detects when a threshold amount of activity occurs after the autonomous software agent has gone to sleep, and in response, the autonomous software agent system 100 wakes up (e.g., activates) the autonomous software agent. In doing so, the autonomous software agent system 100 can reduce resources being idly consumed.

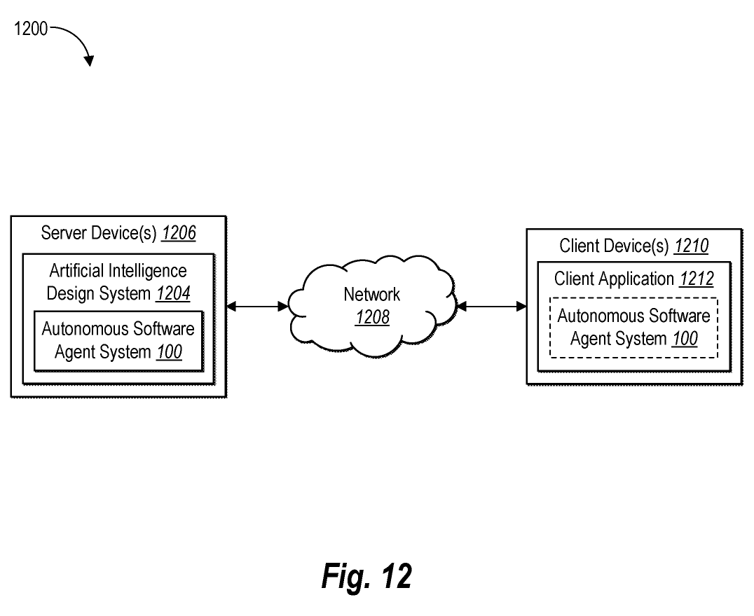

Additional details regarding the autonomous software agent system 100 will now be provided with reference to the figures. For example, FIG. 12 illustrates a schematic diagram of an exemplary system environment 1200 in which an autonomous software agent system 100 operates. As illustrated in FIG. 12, the system environment 1200 includes server device(s) 1206, an artificial intelligence design system 1204, a network 1208, and client device(s) 1210. Additionally, FIG. 12 illustrates that the artificial intelligence design system 1204 includes the autonomous software agent system 100.

Although the system environment 1200 of FIG. 12 is depicted as having a particular number of components, the system environment 1200 is capable of having a different number of additional or alternative components (e.g., a different number of servers, client devices, or other components in communication with the autonomous software agent system 100 via the network 1208). Similarly, although FIG. 12 illustrates a particular arrangement of the server device(s) 1206, the network 1208, and the client device(s) 1210, various additional arrangements are possible.

The server device(s) 1206, the network 1208, and the client device(s) 1210 are communicatively coupled with each other either directly or indirectly (e.g., through the network 1208 discussed in greater detail below). Moreover, the server device(s) 1206 and the client device(s) 1210 include one or more of a variety of computing devices (including one or more computing devices as discussed in greater detail below).

As mentioned above, the system environment 1200 includes the server device(s) 1206. In one or more embodiments, the server device(s) 1206 process input for a request (e.g., a request to configure an autonomous software agent or to deploy an autonomous software agent). In one or more embodiments, the server device(s) 1206 comprise a data server. In some implementations, the server device(s) 1206 comprise a communication server or a web-hosting server. Furthermore, the server device(s) 1206 can be associated with the autonomous software agent system 100 or with an organization/company that deploys the autonomous software agent system 100.

In some embodiments, the client device(s) 1210 includes computing devices associated with the one or more user accounts that submit requests for the autonomous software agent system 100. In some embodiments, the autonomous software agent system 100 trains one or more artificial intelligence models such as a code understanding model, one or more large language models, and a code generation model.

In one or more embodiments, the client device(s) 1210 includes smartphones, tablets, desktop computers, laptop computers, head-mounted-display devices, or other electronic devices. The client device(s) 1210 includes one or more software applications (e.g., the client application 1212) for generating content in accordance with the artificial intelligence design system 1204. In one or more embodiments, the client application 1212 includes a software application hosted on the server device(s) 1206 accessible by the client device(s) 1210 through another application, such as a web browser.

To provide an example implementation, in some embodiments, the autonomous software agent system 100 on the server device(s) 1206 supports the autonomous software agent system 100 on the client device(s) 1210. For instance, in some cases, the artificial intelligence design system 1204 on the server device(s) 1206 gathers data for the autonomous software agent system 100. In response, the autonomous software agent system 100, via the server device(s) 1206, provides the information to the client device(s) 1210. In other words, the client device(s) 1210 obtains (e.g., downloads) the autonomous software agent system 100 from the server device(s) 1206 that is already trained/optimized. Once downloaded, the autonomous software agent system 100 on the client device(s) 1210 is able to perform tasks (e.g., generative software tasks) independent from the server device(s) 1206. In one or more alternative implementations, the autonomous software agent system 100 generates or learns parameters for one or more artificial intelligence models (e.g., used to implement an autonomous software agent) in whole or in part on the client device(s) 1210.

In alternative implementations, the artificial intelligence design system 1204 includes a web hosting application that allows the client device(s) 1210 to interact with content and services hosted on the server device(s) 1206. To illustrate, in one or more implementations, the client device(s) 1210 accesses a software application supported by the server device(s) 1206. In response, the artificial intelligence design system 1204 on the server device(s) 1206 provides tools for monitoring/modifying/generating computer code/artificial intelligence output(s) using the autonomous software agent. In other words, the client device(s) 1210 does not have to download the autonomous software agent system 100 while still being able to access/utilize the trained/optimized tools provided by the artificial intelligence design system 1204 via a web hosting application.

In some embodiments, the autonomous software agent system 100 is implemented in whole, or in part, by the individual elements of the system environment 1200. For instance, although FIG. 12 illustrates the autonomous software agent system 100 implemented or hosted on the server device(s) 1206, different components of the autonomous software agent system 100 are able to be implemented by a variety of devices within the system environment 1200. For example, one or more (or all) components of the autonomous software agent system 100 are implemented by a different computing device or a separate server from the server device(s) 1206. Indeed, as shown in FIG. 12, the client device(s) 1210 includes the autonomous software agent system 100.

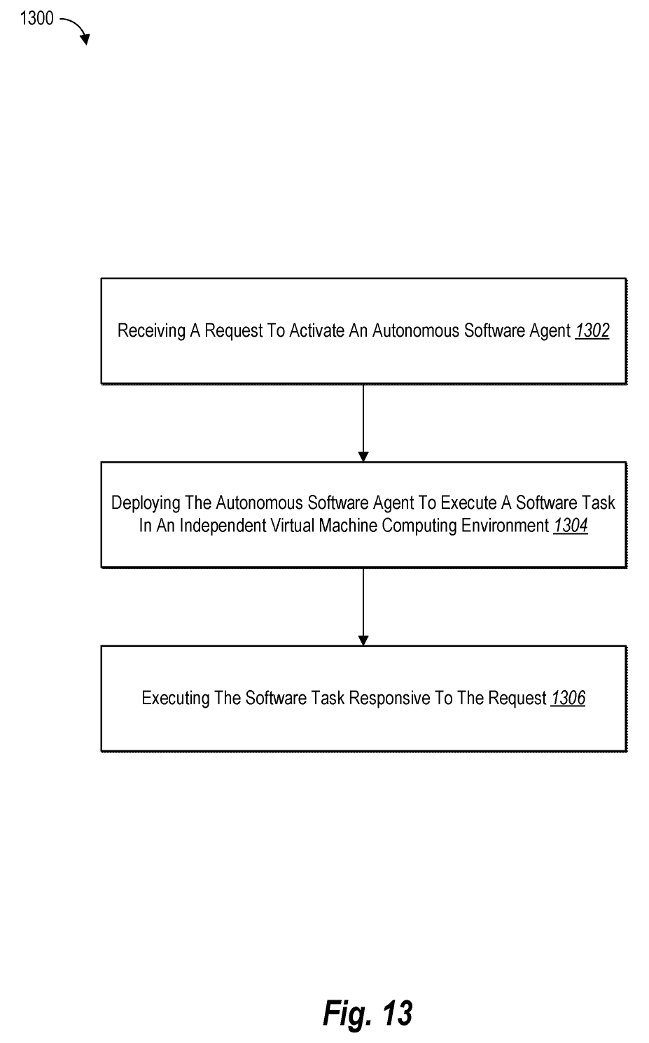

FIG. 13 illustrates a flowchart of a series of acts 1300 for executing a software task responsive to a request in accordance with one or more embodiments. FIG. 13 illustrates acts according to one embodiment, alternative embodiments may omit, add to, reorder, and/or modify any of the acts shown in FIG. 13. In some implementations, the acts of FIG. 13 are performed as part of a method. For example, in some embodiments, the acts of FIG. 13 are performed as part of a computer-implemented method. Alternatively, a non-transitory computer-readable medium stores instructions thereon that, when executed by at least one processor, cause a computing device to perform the acts of FIG. 13. In some embodiments, a system performs the acts of FIG. 13. For example, in one or more embodiments, a system includes at least one memory device. The system further includes at least one server device configured to cause the system to perform the acts of FIG. 13.

The series of acts 1300 includes an act 1302 of receiving a request to activate an autonomous software agent. Further, the series of acts 1300 includes an act 1304 of deploying the autonomous software agent to execute a software task in an independent virtual machine computing environment. Moreover, the series of acts 1300 includes an act 1306 of executing the software task responsive to the request.

In particular, the act 1302 includes receiving, via a graphical user interface, a request to activate an autonomous software agent to execute a software task. Further, the act 1304 includes in response to the request, deploying the autonomous software agent to execute the software task in an independent virtual machine computing environment, the independent virtual machine computing environment comprising a shell and an integrated development environment. Moreover, the act 1306 includes executing, by the autonomous software agent, the software task responsive to the request. The series of acts 1300 also includes the below clauses.

Clause 1. A computer-implemented method comprising: receiving, via a graphical user interface, a request to activate an autonomous software agent to execute a software task; in response to the request, deploying the autonomous software agent to execute the software task in an independent virtual machine computing environment, the independent virtual machine computing environment comprising a shell and an integrated development environment; and executing, by the autonomous software agent, the software task responsive to the request.

Clause 2. The computer-implemented method of clause 1, wherein executing the software task by the autonomous software agent comprises the autonomous software agent switching between the shell and the integrated development environment.

Clause 3. The computer-implemented method of any of clauses 1-2, wherein executing the software task by the autonomous software agent comprises at least one of: utilizing, by the autonomous software agent, the shell to submit terminal commands to an operating system; utilizing, by the autonomous software agent, a browser tool to perform one or more web-based operations; utilizing, by the autonomous software agent, the integrated development environment to write computer code; or utilizing, by the autonomous software agent, a planner tool to decompose the request into a plurality of sub-tasks.

Clause 4. The computer-implemented method of any of clauses 1-3, wherein utilizing, by the autonomous software agent, the planner tool further comprises: extracting, utilizing a large language model, a meta-task from the request received via the graphical user interface; decomposing the meta-task extracted from the request into a plurality of intermediate tasks; and generating an artificial intelligence plan comprising the meta-task and the plurality of intermediate tasks to execute the software task.

Clause 5. The computer-implemented method of any of clauses 1-4, wherein utilizing, by the autonomous software agent, the browser tool further comprises: performing, by the autonomous software agent, a navigation step corresponding to a website domain page; determining, by the autonomous software agent, a document object model of the website domain page; and identifying, utilizing a large language model to analyze the document object model and the software task, relevant document object model elements from the document object model.

Clause 6. The computer-implemented method of any of clauses 1-5, further comprising: generating, utilizing the large language model, a simplified document object model tree based on the relevant document object model elements; and executing the software task based on the simplified document object model tree.

Clause 7. The computer-implemented method of any of clauses 1-6, further comprising: providing for display in the graphical user interface, the integrated development environment with an option to modify the computer code written by the autonomous software agent to execute the software task; and providing for display in the graphical user interface, an option to follow the autonomous software agent as the autonomous software agent switches between the shell, the integrated development environment, the browser tool, and the planner tool.

Clause 8. The computer-implemented method of any of clauses 1-7, further comprising providing in the graphical user interface, one or more of : a text-based interface of the shell that shows input commands from the autonomous software agent as part of executing the software task; a browser that shows browsing tasks performed by the autonomous software agent as part of executing the software task; a code interface of the integrated development environment that shows computer code written by the autonomous software agent as part of executing the software task; or a planner interface that shows planning steps determined by the autonomous software agent as part of executing the software task.

Clause 9. A non-transitory computer-readable medium storing executable instructions which, when executed by at least one processing device, cause the at least one processing device to perform operations comprising: receiving a request to activate an autonomous software agent to execute a software task; in response to the request, deploying the autonomous software agent to execute the software task in an independent virtual machine computing environment; generating an artificial intelligence plan by utilizing a planner tool from the independent virtual machine computing environment to decompose the software task into a plurality of sub-tasks; and executing, by the autonomous software agent utilizing one or more of a shell and an integrated development environment in the independent virtual machine computing environment, the software task responsive to a sub-task of the plurality of sub-tasks.

Clause 10. The non-transitory computer-readable medium of clause 9, wherein deploying the autonomous software agent further comprises initializing a development session comprising the independent virtual machine computing environment hosted on a virtual private cloud and an autonomous agent model backend comprising a set of large language models.

Clause 11. The non-transitory computer-readable medium of any of clauses 9-10, further comprising: identifying a large language model of the set of large language models to execute the sub-task from the artificial intelligence plan; generating, utilizing the large language model to execute the sub-task, an artificial intelligence output; and transmitting the artificial intelligence output from the large language model to the independent virtual machine computing environment hosted on the virtual private cloud.

Clause 12. The non-transitory computer-readable medium of any of clauses 9-11, further comprising: providing, via a graphical user interface, the artificial intelligence plan depicting the plurality of sub-tasks and an option to confirm the artificial intelligence plan; receiving, via the graphical user interface, a selection of the option to confirm the artificial intelligence plan; and deploying the autonomous software agent to execute the software task according to the artificial intelligence plan.

Clause 13. The non-transitory computer-readable medium of any of clauses 9-12, further comprising executing the software task by: determining, utilizing a browser tool of the autonomous software agent, a document object model of a website domain page; transmitting the document object model and the software task to a large language model of an autonomous software agent model backend; identifying, utilizing the large language model to analyze the document object model and the software task, relevant document object model elements from the document object model; and transmitting the relevant document object model elements to the independent virtual machine computing environment.

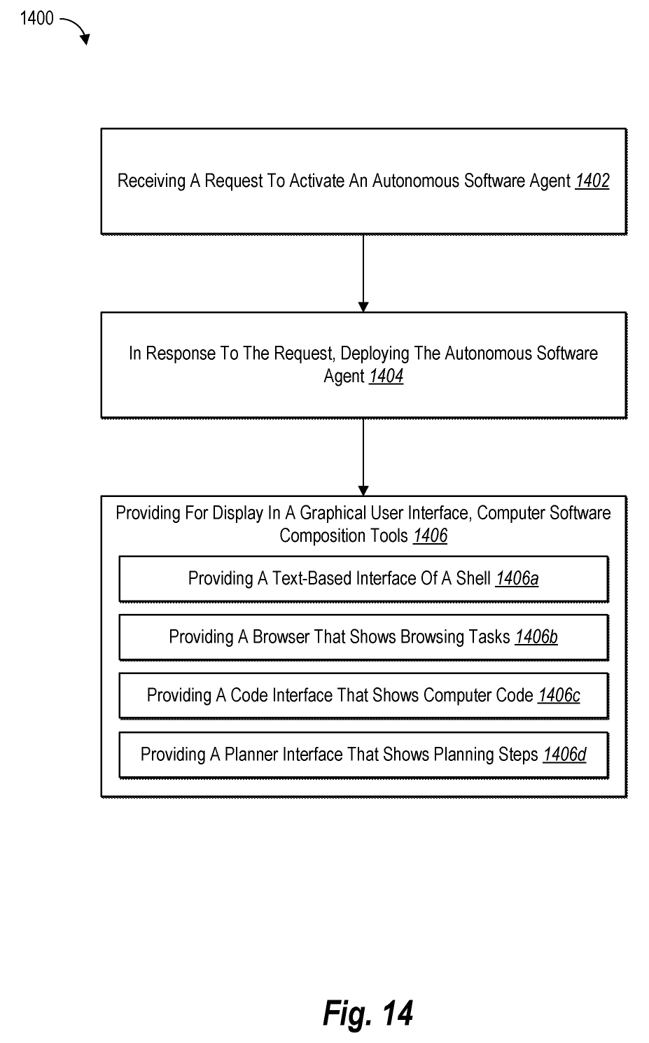

FIG. 14 illustrates a flowchart of a series of acts 1400 for providing for display, computer software composition tools in accordance with one or more embodiments. FIG. 14 illustrates acts according to one embodiment, alternative embodiments may omit, add to, reorder, and/or modify any of the acts shown in FIG. 14. In some implementations, the acts of FIG. 14 are performed as part of a method. For example, in some embodiments, the acts of FIG. 14 are performed as part of a computer-implemented method. Alternatively, a non-transitory computer-readable medium stores instructions thereon that, when executed by at least one processor, cause a computing device to perform the acts of FIG. 14. In some embodiments, a system performs the acts of FIG. 14. For example, in one or more embodiments, a system includes at least one memory device. The system further includes at least one server device configured to cause the system to perform the acts of FIG. 14.

The series of acts 1400 includes an act 1402 of receiving a request to activate an autonomous software agent. Further, the series of acts 1400 includes an act 1404 of in response to the request, deploy the autonomous software agent. Moreover, the series of acts 1400 includes an act 1406 of providing for display in a graphical user interface, computer software composition tools. Further, the act 1406 includes a sub-act 1406a of providing a text-based interface of a shell, a sub-act 1406b of providing a browser that shows browsing tasks, a sub-act 1406c of providing a code interface that shows computer code, and a sub-act 1406d of providing a planner interface that shows planning steps.

In particular, the act 1402 includes receiving, via a graphical user interface, a request to activate an autonomous software agent to execute a software task. Further, the act 1404 includes in response to the request, deploying the autonomous software agent to execute the software task in an independent virtual machine computing environment. Moreover, the act 1406 includes providing for display in the graphical user interface, computer software composition tools of the independent virtual machine computing environment.

Additionally, the sub-act 1406a includes providing a text-based interface of a shell that shows input commands entered by the autonomous software agent as part of executing the software task. Moreover, the sub-act 1406b includes providing a browser that shows browsing tasks performed by the autonomous software agent as part of executing the software task. Further, the sub-act 1406c includes providing a code interface that shows computer code written by the autonomous software agent as part of executing the software task. Additionally, the sub-act 1406d includes providing a planner interface that shows planning step determined by the autonomous software agent as part of executing the software task. The series of acts 1400 also includes the below clauses.

Clause 14. A system comprising: one or more memory devices; and one or more processors coupled to the one or more memory devices, configured to cause the system to: receive, via a graphical user interface, a request to activate an autonomous software agent to execute a software task; in response to the request, deploy the autonomous software agent to execute the software task in an independent virtual machine computing environment; and provide for display in the graphical user interface, computer software composition tools of the independent virtual machine computing environment comprising at least one of: a text-based interface of a shell that shows input commands entered by the autonomous software agent as part of executing the software task; a browser that shows browsing tasks performed by the autonomous software agent as part of executing the software task; a code interface that shows computer code written by the autonomous software agent as part of executing the software task; or a planner interface that shows planning step determined by the autonomous software agent as part of executing the software task.

Clause 15. The system of clause 14, wherein the one or more processors are configured to cause the system to receive the request to activate the autonomous software agent by: receiving, from a third-party messaging application between a plurality of users, a mention that tags the autonomous software agent to execute the software task; and transmitting the mention that tags the autonomous software agent to a virtual private cloud that hosts the independent virtual machine computing environment for the autonomous software agent to execute the software task.

Clause 16. The system of any of clauses 14-15, wherein the one or more processors are configured to cause the system to utilize the autonomous software agent to execute the software task by transmitting encrypted communications between the virtual private cloud that hosts the independent virtual machine computing environment and an autonomous agent model backend comprising a set of large language models.

Clause 17. The system of any of clauses 14-16, wherein the one or more processors are configured to cause the system to: determine, utilizing a planner tool, a meta-task from the request received from the graphical user interface; decompose, utilizing the planner tool, the meta-task into a plurality of sub-tasks; and generating, utilizing the planner tool, an artificial intelligence plan comprising the meta-task and the plurality of sub-tasks.

Clause 18. The system of any of clauses 14-17, wherein the one or more processors are configured to cause the system to: provide, via the graphical user interface, the artificial intelligence plan depicting the meta-task and the plurality of sub-tasks and an option to modify the artificial intelligence plan; receive, via the graphical user interface, one or more user inputs to modify the artificial intelligence plan; and deploy the autonomous software agent to execute the software task according to a modified artificial intelligence plan based on the one or more user inputs.

Clause 19. The system of any of clauses 14-18, wherein the one or more processors are configured to cause the system to: provide, as part of the code interface, an option to modify the computer code written by the autonomous software agent; and provide, as part of the code interface, an option to follow the autonomous software agent as the autonomous software agent switches between the text-based interface, the browser, the code interface, and the planner interface.

Clause 20. The system of any of clauses 14-19, wherein the one or more processors are configured to cause the system to provide, as part of the text-based interface, an option for a user to submit terminal commands in addition to terminal commands submitted by the autonomous software agent.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed by a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multiprocessor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

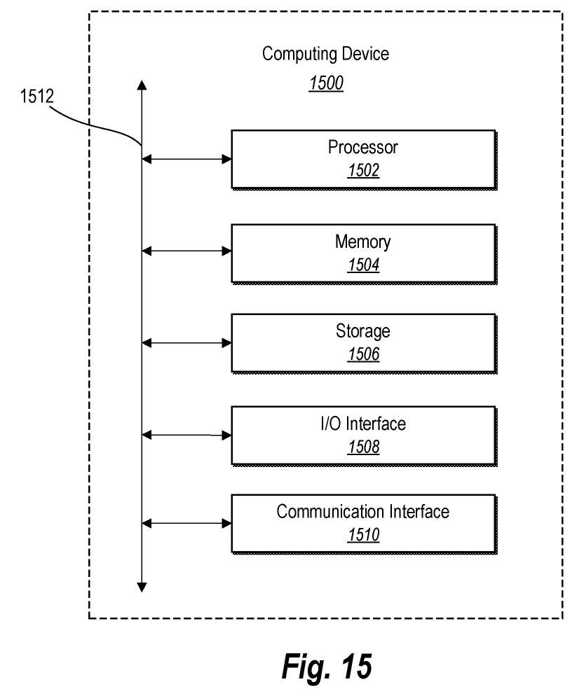

FIG. 15 illustrates a block diagram of an example computing device 1500 that may be configured to perform one or more of the processes described above. One will appreciate that one or more computing devices, such as the computing device 1500 may represent the computing devices described above (e.g., the server device(s) 1206 and/or the client device(s) 1210). In one or more embodiments, the computing device 1500 may be a mobile device (e.g., a mobile telephone, a smartphone, a PDA, a tablet, a laptop, a camera, a tracker, a watch, a wearable device). In some embodiments, the computing device 1500 may be a non-mobile device (e.g., a desktop computer or another type of client device). Further, the computing device 1500 may be a server device that includes cloud-based processing and storage capabilities.

As shown in FIG. 15, the computing device 1500 can include one or more processor(s) 1502, memory 1504, a storage device 1506, input/output interfaces 1508 (or “I/O interfaces 1508”), and a communication interface 1510, which may be communicatively coupled by way of a communication infrastructure (e.g., bus 1512). While the computing device 1500 is shown in FIG. 15, the components illustrated in FIG. 15 are not intended to be limiting. Additional or alternative components may be used in other embodiments. Furthermore, in certain embodiments, the computing device 1500 includes fewer components than those shown in FIG. 15. Components of the computing device 1500 shown in FIG. 15 will now be described in additional detail.

In particular embodiments, the processor(s) 1502 include hardware for executing instructions, such as those making up a computer program. As an example, and not by way of limitation, to execute instructions, the processor(s) 1502 may retrieve (or fetch) the instructions from an internal register, an internal cache, memory 1504, or a storage device 1506 and decode and execute them.

The computing device 1500 includes memory 1504, which is coupled to the processor(s) 1502. The memory 1504 may be used for storing data, metadata, and programs for execution by the processor(s). The memory 1504 may include one or more of volatile and non-volatile memories, such as Random-Access Memory (“RAM”), Read-Only Memory (“ROM”), a solid-state disk (“SSD”), Flash, Phase Change Memory (“PCM”), or other types of data storage. The memory 1504 may be internal or distributed memory.

The computing device 1500 includes a storage device 1506 including storage for storing data or instructions. As an example, and not by way of limitation, the storage device 1506 can include a non-transitory storage medium described above. The storage device 1506 may include a hard disk drive (HDD), flash memory, a Universal Serial Bus (USB) drive or a combination these or other storage devices.

As shown, the computing device 1500 includes one or more I/O interfaces 1508, which are provided to allow a user to provide input to (such as user strokes), receive output from, and otherwise transfer data to and from the computing device 1500. These I/O interfaces 1508 may include a mouse, keypad or a keyboard, a touch screen, camera, optical scanner, network interface, modem, other known I/O devices or a combination of such I/O interfaces 1508. The touch screen may be activated with a stylus or a finger.

The I/O interfaces 1508 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O interfaces 1508 are configured to provide graphical data to a display for presentation to a user. The graphical data may be representative of one or more graphical user interfaces and/or any other graphical content as may serve a particular implementation.

The computing device 1500 can further include a communication interface 1510. The communication interface 1510 can include hardware, software, or both. The communication interface 1510 provides one or more interfaces for communication (such as, for example, packet-based communication) between the computing device and one or more other computing devices or one or more networks. As an example, and not by way of limitation, communication interface 1510 may include a network interface controller (NIC) or network adapter for communicating with an Ethernet or other wire-based network or a wireless NIC (WNIC) or wireless adapter for communicating with a wireless network, such as a WI-FI. The computing device 1500 can further include a bus 1512. The bus 1512 can include hardware, software, or both that connects components of computing device 1500 to each other.

In the foregoing specification, the invention has been described with reference to specific example embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel to one another or in parallel to different instances of the same or similar steps/acts. The scope of the invention is, therefore, indicated by the appended claims rather than by the foregoing description. All changes that come within the meaning and range of equivalency of the claims are to be embraced within their scope.

What is claimed:

1. A computer-implemented method comprising:
receiving, via a graphical user interface, a request to activate an autonomous software agent to execute a software task;
in response to the request, deploying the autonomous software agent to execute the software task in an independent virtual machine computing environment, the independent virtual machine computing environment comprising a shell and an integrated development environment; and
executing, by the autonomous software agent, the software task responsive to the request.

2. The computer-implemented method of claim 1, wherein executing the software task by the autonomous software agent comprises the autonomous software agent switching between the shell and the integrated development environment.

3. The computer-implemented method of claim 1, wherein executing the software task by the autonomous software agent comprises at least one of:
utilizing, by the autonomous software agent, the shell to submit terminal commands to an operating system;
utilizing, by the autonomous software agent, a browser tool to perform one or more web-based operations;
utilizing, by the autonomous software agent, the integrated development environment to write computer code; or
utilizing, by the autonomous software agent, a planner tool to decompose the request into a plurality of sub-tasks.

4. The computer-implemented method of claim 3, wherein utilizing, by the autonomous software agent, the planner tool further comprises:
extracting, utilizing a large language model, a meta-task from the request received via the graphical user interface;
decomposing the meta-task extracted from the request into a plurality of intermediate tasks; and
generating an artificial intelligence plan comprising the meta-task and the plurality of intermediate tasks to execute the software task.

5. The computer-implemented method of claim 3, wherein utilizing, by the autonomous software agent, the browser tool further comprises:
performing, by the autonomous software agent, a navigation step corresponding to a website domain page;
determining, by the autonomous software agent, a document object model of the website domain page; and
identifying, utilizing a large language model to analyze the document object model and the software task, relevant document object model elements from the document object model.

6. The computer-implemented method of claim 5, further comprising:
generating, utilizing the large language model, a simplified document object model tree based on the relevant document object model elements; and
executing the software task based on the simplified document object model tree.

7. The computer-implemented method of claim 3, further comprising:
providing for display in the graphical user interface, the integrated development environment with an option to modify the computer code written by the autonomous software agent to execute the software task; and
providing for display in the graphical user interface, an option to follow the autonomous software agent as the autonomous software agent switches between the shell, the integrated development environment, the browser tool, and the planner tool.

8. The computer-implemented method of claim 1, further comprising providing in the graphical user interface, one or more of:
a text-based interface of the shell that shows input commands from the autonomous software agent as part of executing the software task;
a browser that shows browsing tasks performed by the autonomous software agent as part of executing the software task;
a code interface of the integrated development environment that shows computer code written by the autonomous software agent as part of executing the software task; or
a planner interface that shows planning steps determined by the autonomous software agent as part of executing the software task.

9. A system comprising:
one or more memory devices; and
one or more processors coupled to the one or more memory devices, configured to cause the system to:
receive, via a graphical user interface, a request to activate an autonomous software agent to execute a software task;
in response to the request, deploy the autonomous software agent to execute the software task in an independent virtual machine computing environment; and
provide for display in the graphical user interface, computer software composition tools of the independent virtual machine computing environment comprising at least one of:
a text-based interface of a shell that shows input commands entered by the autonomous software agent as part of executing the software task;
a browser that shows browsing tasks performed by the autonomous software agent as part of executing the software task;
a code interface that shows computer code written by the autonomous software agent as part of executing the software task; or
a planner interface that shows planning step determined by the autonomous software agent as part of executing the software task.

10. The system of claim 9, wherein the one or more processors are configured to cause the system to receive the request to activate the autonomous software agent by:
receiving, from a third-party messaging application between a plurality of users, a mention that tags the autonomous software agent to execute the software task; and
transmitting the mention that tags the autonomous software agent to a virtual private cloud that hosts the independent virtual machine computing environment for the autonomous software agent to execute the software task.

11. The system of claim 10, wherein the one or more processors are configured to cause the system to utilize the autonomous software agent to execute the software task by transmitting encrypted communications between the virtual private cloud that hosts the independent virtual machine computing environment and an autonomous agent model backend comprising a set of large language models.

12. The system of claim 9, wherein the one or more processors are configured to cause the system to:
determine, utilizing a planner tool, a meta-task from the request received from the graphical user interface;
decompose, utilizing the planner tool, the meta-task into a plurality of sub-tasks; and
generating, utilizing the planner tool, an artificial intelligence plan comprising the meta-task and the plurality of sub-tasks.

13. The system of claim 12, wherein the one or more processors are configured to cause the system to:
provide, via the graphical user interface, the artificial intelligence plan depicting the meta-task and the plurality of sub-tasks and an option to modify the artificial intelligence plan;
receive, via the graphical user interface, one or more user inputs to modify the artificial intelligence plan; and
deploy the autonomous software agent to execute the software task according to a modified artificial intelligence plan based on the one or more user inputs.

14. The system of claim 9, wherein the one or more processors are configured to cause the system to:
provide, as part of the code interface, an option to modify the computer code written by the autonomous software agent; and
provide, as part of the code interface, an option to follow the autonomous software agent as the autonomous software agent switches between the text-based interface, the browser, the code interface, and the planner interface.

15. The system of claim 9, wherein the one or more processors are configured to cause the system to provide, as part of the text-based interface, an option for a user to submit terminal commands in addition to terminal commands submitted by the autonomous software agent.

16. A non-transitory computer-readable medium storing executable instructions which, when executed by at least one processing device, cause the at least one processing device to perform operations comprising:
receiving a request to activate an autonomous software agent to execute a software task;
in response to the request, deploying the autonomous software agent to execute the software task in an independent virtual machine computing environment;
generating an artificial intelligence plan by utilizing a planner tool from the independent virtual machine computing environment to decompose the software task into a plurality of sub-tasks; and
executing, by the autonomous software agent utilizing one or more of a shell and an integrated development environment in the independent virtual machine computing environment, the software task responsive to a sub-task of the plurality of sub-tasks.

17. The non-transitory computer-readable medium of claim 16, wherein deploying the autonomous software agent further comprises initializing a development session comprising the independent virtual machine computing environment hosted on a virtual private cloud and an autonomous agent model backend comprising a set of large language models.

18. The non-transitory computer-readable medium of claim 17, further comprising:
identifying a large language model of the set of large language models to execute the sub-task from the artificial intelligence plan;
generating, utilizing the large language model to execute the sub-task, an artificial intelligence output; and
transmitting the artificial intelligence output from the large language model to the independent virtual machine computing environment hosted on the virtual private cloud.

19. The non-transitory computer-readable medium of claim 16, further comprising:
providing, via a graphical user interface, the artificial intelligence plan depicting the plurality of sub-tasks and an option to confirm the artificial intelligence plan;
receiving, via the graphical user interface, a selection of the option to confirm the artificial intelligence plan; and
deploying the autonomous software agent to execute the software task according to the artificial intelligence plan.

20. The non-transitory computer-readable medium of claim 16, further comprising executing the software task by:
determining, utilizing a browser tool of the autonomous software agent, a document object model of a website domain page;
transmitting the document object model and the software task to a large language model of an autonomous software agent model backend;
identifying, utilizing the large language model to analyze the document object model and the software task, relevant document object model elements from the document object model; and
transmitting the relevant document object model elements to the independent virtual machine computing environment.
